(19) United States
(12) Patent Application Publication
(10) Pub. No.: US 2026/0254189 A1
(43) Pub. Date: Aug. 27, 2026

(54) DUAL-BEAM COMBINING LASER FREQUENCY-DOUBLING DEVICES

(71) Applicant: ANHUI HUACHUANG HONGDU PHOTOELECTRIC TECHNOLOGY CO., LTD., Hefei (CN)

(72) Inventors: Rang ZENG, Hefei (CN); Qingbang SHU, Hefei (CN); Gensheng ZHA, Hefei (CN); Weiqing GAO, Hefei (CN); Congke WANG, Hefei (CN); Weilin QIN, Hefei (CN); Song HUANG, Hefei (CN); Xiaohui MA, Hefei (CN)

(73) Assignee: ANHUI HUACHUANG HONGDU PHOTOELECTRIC TECHNOLOGY CO., LTD., Hefei (CN)

(21) Appl. No.: 19/298,150

(22) Filed: Aug. 12, 2025

(30) Foreign Application Priority Data
Feb. 27, 2025 (CN) 202510224129.9

(51) Int. Cl. H01S 3/109; G02F 1/355; G02F 1/37

(52) U.S. Cl. CPC H01S 3/109; G02F 1/3551; G02F 1/37

(57) ABSTRACT

Provided is a dual-beam combining laser frequency-doubling device. A first frequency-doubling module and a second frequency-doubling module of the dual-beam combining laser frequency-doubling device share a dual-sided harmonic separation mirror. The first frequency-doubling module includes a first harmonic separation mirror and a first frequency-doubling crystal. The second frequency-doubling module includes a second harmonic separation mirror and a second frequency-doubling crystal. An end of the first harmonic separation mirror is connected to an end of the first frequency-doubling crystal. Another end of the first frequency-doubling crystal is connected to an end of the dual-sided harmonic separation mirror. Another end of the dual-sided harmonic separation mirror is connected to an end of the second frequency-doubling crystal. Another end of the second frequency-doubling crystal is connected to an end of the second harmonic separation mirror.

### CROSS-REFERENCE TO RELATED APPLICATIONS

This application claims priority to Chinese Application No. 202510224129.9 filed on Feb. 27, 2025, the entire contents of which are incorporated herein by reference.

### TECHNICAL FIELD

The present disclosure generally relates to the field of laser frequency-doubling, and in particular, to a dual-beam combining laser frequency-doubling device.

### BACKGROUND

As one of the most cutting-edge technologies in the 21st century, the laser processing technology has excellent application value and broad application prospects in a plurality of fields such as scientific research, medical treatment, industrial processing, military defense, etc. In particular, short-wave lasers have unique application scenarios. However, spectral features of a laser gain medium limit an output wavelength range of a solid laser. Laser frequency-doubling is a frequency conversion technology that generates second harmonics through a nonlinear crystal, enabling high-efficiency, high-power, and high-beam-quality short-wavelength laser output.

The laser frequency-doubling mainly includes an intracavity frequency-doubling technique and an extracavity frequency-doubling technique. Due to a high threshold of a frequency-doubling crystal, achieving a high frequency-doubling efficiency requires a high power density of a fundamental frequency laser. Therefore, for a continuous-wave laser or a high-repetition-rate laser, the intracavity frequency-doubling technique is generally used. However, an intracavity power is constrained by factors such as an output capability and stability of a fundamental resonant cavity, thereby limiting the output capability of the frequency-doubled laser. The extracavity frequency-doubling technique offers better stability since a frequency-doubling device is located outside the cavity. However, since the fundamental frequency laser passes through the nonlinear crystal only once, the conversion efficiency is relatively low. To obtain a stronger frequency-doubled laser, a higher-power fundamental frequency laser or multi-beam fundamental frequency laser combining before frequency-doubling is required.

Existing dual-beam combining frequency-doubling techniques generally involve beam combining before frequency-doubling or frequency-doubling before beam combining, mainly including a spatial beam combining technique, a fiber beam combining technique, and a polarization beam combining technique. The spatial beam combining technique uses reflective components to keep two beams parallel in space, performing beam combining before frequency-doubling or frequency-doubling before beam combining. Essentially, the spatial beam combining technique outputs two parallel laser beams with high adjustment difficulty. The fiber beam combining technique involves coupling two beams into the same fiber through total reflection, performing beam combining before frequency-doubling or frequency-doubling before beam combining. However, the quality of the laser beam obtained through the fiber beam combining technique is poor. The polarization beam combining technique couples two laser beams with different polarization states based on polarization characteristics of the two laser beams. If beam combining is performed before frequency-doubling, only Type II phase-matching doubling can be used, resulting in low conversion efficiency. If frequency-doubling is performed before beam combining, the combined laser beam loses its polarization properties.

Therefore, the existing dual-beam combining frequency-doubling techniques face challenges such as high adjustment difficulty, degradation of laser beam quality, low frequency-doubling efficiency, and the loss of polarization characteristics in linearly polarized lasers, limiting their applications.

### SUMMARY

The purpose of the present disclosure is to solve the above problems and to propose a dual-beam combining laser frequency-doubling device.

Example embodiments of the present disclosure propose a dual-beam combining laser frequency-doubling device. The device includes a first frequency-doubling module and a second frequency-doubling module.

The first frequency-doubling module and the second frequency-doubling module share a dual-sided harmonic separation mirror.

The first frequency-doubling module includes a first harmonic separation mirror and a first frequency-doubling crystal; the second frequency-doubling module includes a second harmonic separation mirror and a second frequency-doubling crystal.

An end of the first harmonic separation mirror is connected to an end of the first frequency-doubling crystal, and another end of the first frequency-doubling crystal is connected to an end of the dual-sided harmonic separation mirror.

Another end of the dual-sided harmonic separation mirror is connected to an end of the second frequency-doubling crystal, and another end of the second frequency-doubling crystal is connected to an end of the second harmonic separation mirror.

### BRIEF DESCRIPTION OF THE DRAWINGS

The present disclosure is further described by way of exemplary embodiments. These exemplary embodiments are described in detail with reference to the drawings. These embodiments are non-limiting exemplary embodiments, where like reference numerals represent similar structures throughout the several views of the drawings, and wherein:

FIG. 1 is a schematic diagram illustrating an exemplary structure of a dual-beam combining laser frequency-doubling device according to some embodiments of the present disclosure;

FIG. 2 is a schematic diagram illustrating superposition of two pulsed laser beams according to some embodiments of the present disclosure;

FIG. 3 is another schematic diagram illustrating superposition of two pulsed laser beams according to some embodiments of the present disclosure;

FIG. 4 is a further schematic diagram illustrating superposition of two pulsed laser beams according to some embodiments of the present disclosure;

FIG. 5 is a schematic diagram illustrating an exemplary structure of an extracavity frequency-doubling dual-beam combining laser frequency-doubling device according to some embodiments of the present disclosure;

FIG. 6 is a schematic diagram illustrating an exemplary structure of an intracavity dual-beam combining laser frequency-doubling device according to some embodiments of the present disclosure;

FIG. 7(a) is a schematic diagram illustrating an exemplary structure of a dual-beam combining laser frequency-doubling device according to some embodiments of the present disclosure;

FIG. 7(b) is a schematic diagram illustrating an exemplary structure of a dual-beam combining laser frequency-doubling device according to some embodiments of the present disclosure;

FIG. 7(c) is a schematic diagram illustrating an exemplary structure of a dual-beam combining laser frequency-doubling device according to some embodiments of the present disclosure;

FIG. 8 is a schematic diagram illustrating an exemplary structure of a dual-beam combining laser frequency-doubling device according to some embodiments of the present disclosure;

FIG. 9 is a schematic diagram illustrating an exemplary structure of a dual-beam combining laser frequency-doubling device according to some embodiments of the present disclosure; and

FIG. 10 is a schematic diagram illustrating an exemplary structure of a comprehensive control model according to some embodiments of the present disclosure.

Numerals in the drawings: 1, first frequency-doubling module; 101, first fundamental-frequency high-reflectivity cavity mirror; 102, first working crystal; 103, first harmonic separation mirror; 104, first frequency-doubling crystal; 105, dual-sided harmonic separation mirror; 2, second frequency-doubling module; 201, second fundamental-frequency high-reflectivity cavity mirror; 202, second working crystal; 203, second harmonic separation mirror; 204, second frequency-doubling crystal; 3, first fundamental frequency laser generation module; 4, second fundamental frequency laser generation module; 5, temperature sensor; 6, thermoelectric cooler; 7, processor; 8, displacement sensor; 9, piezoe-lectric transducer; 10, electro-optical modulator; 11, first signal acquisition device; 12, second signal acquisition device; 13, comprehensive control model.

### DETAILED DESCRIPTION

To more clearly illustrate the technical solutions of the embodiments of the present disclosure, the following will briefly introduce the accompanying drawings that need to be used in the description of the embodiments. Obviously, the accompanying drawings in the following description are only some examples or embodiments of the present disclosure, and it is possible for those skilled in the art to apply the present disclosure to other similar scenarios in accordance with these drawings without creative labor. The present disclosure may be applied to other similar scenarios based on these drawings without creative labor. Unless obviously obtained from the context or the context illustrates otherwise, the same numeral in the drawings refers to the same structure or operation.

The term “and/or” as used herein denotes an inclusive relationship between the associated elements. For example, “A and/or B” means A alone, B alone, or both A and B together.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It will be understood that the terms “system,” “engine,” “unit,” “module,” and/or “block” used herein are one method to distinguish different components, elements, parts, sections, or assemblies of different levels in ascending order. However, the terms may be displaced by another expression if they achieve the same purpose.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowchart.

All other embodiments that may be conceived by those skilled in the art based on the embodiments of the present disclosure without inventive effort are within the scope of the present disclosure.

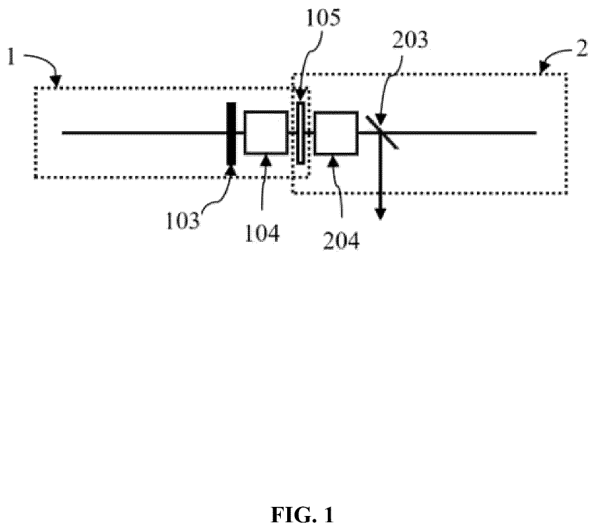

Embodiments of the present disclosure also provide a dual-beam combining laser frequency-doubling device. Referring to FIG. 1, FIG. 1 is a schematic diagram illustrating an exemplary structure of a dual-beam combining laser frequency-doubling device according to some embodiments of the present disclosure. The dual-beam combining laser frequency-doubling device (also referred to as the laser frequency-doubling device for brevity) includes a first frequency-doubling module 1 and a second frequency-doubling module 2.

In some embodiments, the first frequency-doubling module 1 and the second frequency-doubling module 2 share a dual-sided harmonic separation mirror 105. For example, the dual-sided harmonic separation mirror may be arranged between the first frequency-doubling module 1 and the second frequency-doubling module 2.

The first frequency-doubling module 1 includes a first harmonic separation mirror 103 and a first frequency-doubling crystal 104. The second frequency-doubling module 2 includes a second harmonic separation mirror 203 and a second frequency-doubling crystal 204. An end of the first harmonic separation mirror 103 is connected to an end of the first frequency-doubling crystal 104. Another end of the first frequency-doubling crystal 104 is connected to an end of the dual-sided harmonic separation mirror 105. Another end of the dual-sided harmonic separation mirror 105 is connected to an end of the second frequency-doubling crystal 204, another end of the second frequency-doubling crystal 204 is connected to an end of the second harmonic separation mirror 203.

The first frequency-doubling module 1 refers to a module that combines two fundamental frequency laser beams through a nonlinear optical crystal and uses a second-order nonlinear effect to achieve frequency doubling, thereby generating a frequency-doubled laser. In some embodiments, the first frequency-doubling module may include a fundamental frequency laser source, a beam combiner, a nonlinear crystal, and a phase-matching device. The fundamental frequency laser source may provide the two fundamental frequency laser beams with the same or different wavelengths. For example, the two fundamental frequency laser beams may be continuous-waves or pulsed lasers. The beam combiner merges the two fundamental frequency laser beams into a single beam while ensuring spatial overlap and phase matching. The nonlinear crystal generates the second harmonic. The phase-matching device enables phase matching between the fundamental frequency laser and the frequency-doubled laser to maximize conversion efficiency.

The first harmonic separation mirror 103 is configured to spatially separate the fundamental frequency laser and the frequency-doubled laser. Through a coating design (e.g., dielectric film reflectance or transmission properties), the first harmonic separation mirror 103 may reflect the frequency-doubled laser and transmit the fundamental frequency laser, thereby achieving spatial separation of the fundamental frequency laser and the frequency-doubled laser. In some embodiments, a front side of the first harmonic separation mirror 103 may be provided with a highly reflective dielectric coating that achieves a high reflectivity (e.g., the reflectivity is greater than 95%) for the frequency-doubled laser, and a back side of the first harmonic separation mirror 103 may be provided with an antireflective coating that reduces reflective losses and improves transmission efficiency.

The first frequency-doubling crystal 104 refers to a nonlinear optical crystal that converts the fundamental frequency laser into the frequency-doubled laser. Through a second-order nonlinear effect (e.g., second harmonic generation, SHG), the first frequency-doubling crystal 104 generates the frequency-doubled laser from the incident fundamental beam under high-intensity laser irradiation. In some embodiments, the first frequency-doubling crystal 104 may be an LBO (LiB3O5) crystal, a KTP (KTiOPO4) crystal, a CLBO (CsLiB6O10) crystal, a PPLN (Periodically Poled Lithium Niobate) crystal, a BBO (β-Barium Borate) crystal, or the like.

The second frequency-doubling module 2 is similar to the first frequency-doubling module 1, and more descriptions may be found elsewhere in the present disclosure (e.g., the first frequency-doubling module 1 and related descriptions thereof). In some embodiments, the second frequency-doubling module 2 is configured to output a target frequency-doubled laser.

The second harmonic separation mirror 203 is similar to the first harmonic separation mirror 103, and more descriptions may be found elsewhere in the present disclosure (e.g., the first harmonic separation mirror 103 and related descriptions thereof). In some embodiments, the second harmonic separation mirror 203 is configured to reflect and output the target frequency-doubled laser.

The second frequency-doubling crystal 204 is similar to the first frequency-doubling crystal 104, and more descriptions may be found elsewhere in the present disclosure (e.g., the first frequency-doubling crystal 104 and related descriptions thereof).

The dual-sided harmonic separation mirror 105 refers to an optical element with different coatings on two side surfaces, and is configured to spatially separate two beams of different wavelengths (e.g., the fundamental frequency laser, the frequency-doubled laser, and different harmonic components) simultaneously or separately. In some embodiments, the two side surfaces of the dual-sided harmonic separation mirror 105 may be coated with reflective or transmissive coatings for different wavelengths. For example, one surface reflects the frequency-doubled laser while transmitting the fundamental frequency laser, and the other surface reflects higher-order harmonics or separates other wavelength combinations.

In some embodiments, the fundamental frequency laser may pass through the first harmonic separation mirror 103 and the second harmonic separation mirror 203, and the frequency-doubled laser is reflected by the first harmonic separation mirror 103 and the second harmonic separation mirror 203. After the fundamental frequency laser passes through the first frequency-doubling crystal 104 or the second frequency-doubling crystal 204, frequency-doubling is performed on the fundamental frequency laser to obtain the frequency-doubled laser. The frequency-doubled laser may pass through the dual-sided harmonic separation mirror 105, and the fundamental frequency laser is reflected by the dual-sided harmonic separation mirror 105. When the frequency-doubled laser passes through the first frequency-doubling crystal 104 or the second frequency-doubling crystal 204 again, it remains as the frequency-doubled laser.

In some embodiments, after the fundamental frequency laser passes through the frequency-doubling crystals (e.g., the first frequency-doubling crystal 104 and the second frequency-doubling crystal 204), a portion of the fundamental frequency laser is converted into the frequency-doubled laser. In other words, after the fundamental frequency laser passes through the frequency-doubling crystals (e.g., the first frequency-doubling crystal 104 and the second frequency-doubling crystal 204), the output may include the frequency-doubled laser generated from the frequency-doubling of the fundamental frequency laser and the unconverted fundamental frequency laser. After the frequency-doubled laser passes through the frequency-doubling crystals (e.g., the first frequency-doubling crystal 104 and the second frequency-doubling crystal 204), no further frequency-doubling conversion occurs. That is to say, the frequency-doubled laser directly transmits through the frequency-doubling crystal.

In some embodiments, the first frequency-doubling module 1 and the second frequency-doubling module 2 may be applied to extracavity frequency-doubling. The extracavity frequency-doubling refers to arranging frequency-doubling crystals (e.g., the first frequency-doubling crystal 104 and the second frequency-doubling crystal 204) outside a laser resonant cavity (a laser cavity) to perform frequency conversion. The combined beam passes through the frequency-doubling crystals (e.g., the first frequency-doubling crystal 104 and the second frequency-doubling crystal 204) outside the cavity, the fundamental frequency laser is doubled through the nonlinear effect of the crystals to generate the frequency-doubled laser.

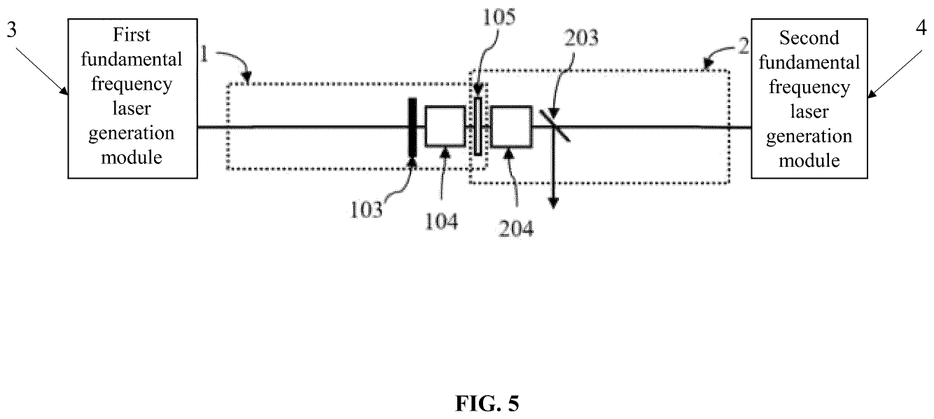

In some embodiments, the two fundamental frequency laser beams may be combined into a single beam through the first harmonic separation mirror 103 and/or the second harmonic separation mirror 203, and the combined beam passes through the frequency-doubling crystals (e.g., the first frequency-doubling crystal 104 and the second frequency-doubling crystal 204) to generate the frequency-doubled laser under a high-intensity field. Through harmonic separation mirrors (e.g., the first harmonic separation mirror 103, the second harmonic separation mirror 203, and the dual-sided harmonic separation mirror 105), the frequency-doubled laser is extracted from an optical path, and the unconverted fundamental frequency laser is blocked or recycled. More descriptions regarding the extracavity frequency-doubling may be found elsewhere in the present disclosure (e.g., FIG. 5 and related descriptions thereof).

In some embodiments, the first frequency-doubling module 1 and the second frequency-doubling module 2 may be applied to intracavity frequency-doubling. The intracavity frequency-doubling refers to arranging the frequency-doubling crystals (e.g., the first frequency-doubling crystal 104 and the second frequency-doubling crystal 204) directly inside the laser resonant cavity (the laser cavity) to achieve highly efficient frequency conversion through an enhanced optical field inside the laser resonant cavity.

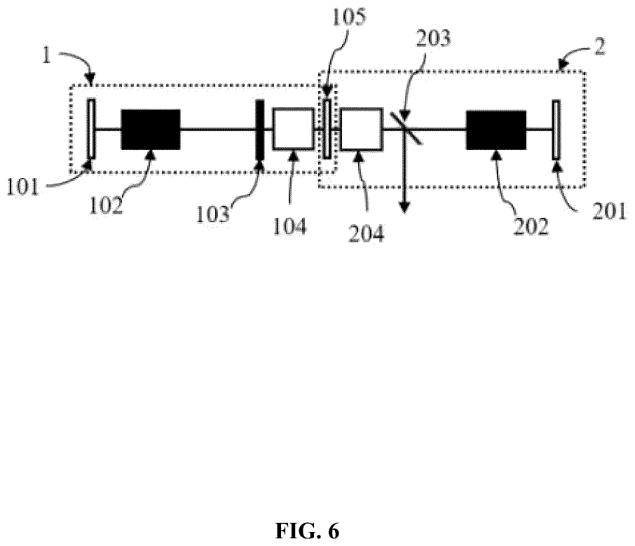

In some embodiments, the two fundamental frequency laser beams may enter the laser resonant cavity from separate paths and be combined into a single beam through the first harmonic separation mirror 103 and/or the second harmonic separation mirror 203. The combined fundamental frequency laser undergoes multiple round trips within the cavity, thus the power density of the fundamental frequency laser is significantly increased. The high-power-density fundamental frequency laser passes through the frequency-doubling crystals (e.g., the first frequency-doubling crystal 104 and the second frequency-doubling crystal 204), where the frequency-doubled laser is generated via the second-order nonlinear effect. The second harmonic separation mirror 203 outputs the frequency-doubled laser from the second frequency-doubling module 2, while the unconverted fundamental frequency laser continues to circulate within the cavity. More descriptions regarding the intracavity frequency-doubling may be found elsewhere in the present disclosure (e.g., FIG. 6 and related descriptions thereof).

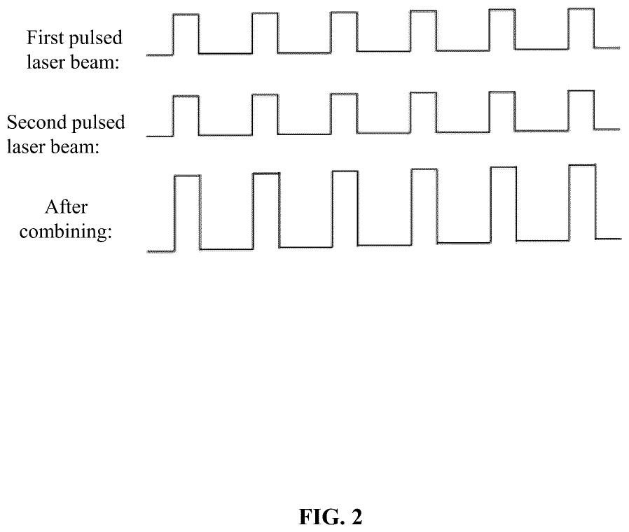

In some embodiments, the first frequency-doubling module 1 and the second frequency-doubling module 2 may adjust an interval between pulsed laser beams by controlling an intracavity pulse delay to achieve pulse overlap for single-pulse energy enhancement at the same repetition rate, or pulsed laser beam interleaving to increase a repetition rate and an average power. Real-time pulse energy editing, etc., may also be achieved by adjusting output powers of the two cavities (e.g., the laser resonant cavity in which the first frequency-doubling module 1 is located and the laser resonant cavity in which the second frequency-doubling module 2 is located). More descriptions may be found elsewhere in the present disclosure (e.g., FIGS. 2-4 and related descriptions thereof).

In some embodiments, the first frequency-doubling module 1 and the second frequency-doubling module 2 may control the intracavity pulse delay and regulate the pulse intervals through a pulse delay regulation element. The pulse delay regulation element may include an electro-optical modulator, an acousto-optic modulator, a fiber optic delay line, a programmable optical delay line, or the like.

In some embodiments, the first frequency-doubling module 1 and the second frequency-doubling module 2 may control the intracavity pulse delay to synchronize or nearly synchronize the arrival of two pulsed laser beams at the frequency-doubling crystals (e.g., the first frequency-doubling crystal 104 and the second frequency-doubling crystal 204), which allows the pulse energies of the two pulsed laser beams to be combined before frequency doubling, thereby enhancing the single-pulse energy output from the second frequency-doubling module 2, while maintaining the same repetition rate.

In some embodiments, the first frequency-doubling module 1 and the second frequency-doubling module 2 may control the intracavity pulse delay such that the two pulsed laser beams arrive at the frequency-doubling crystals (e.g., the first frequency-doubling crystal 104 and the second frequency-doubling crystal 204) with a temporal offset (e.g., a delay equal to half or an integer multiple of the pulse period), allowing the pulses to alternately pass through the frequency-doubling crystals. As a result, the repetition rate of the output pulse sequence from the second frequency-doubling module 2 is doubled, while the single-pulse energy remains unchanged, thereby increasing the average power.

In some embodiments, the first frequency-doubling module 1 and the second frequency-doubling module 2 may achieve the real-time pulse energy editing by adjusting the output powers of the two cavities (e.g., the laser resonant cavity in which the first frequency-doubling module 1 is located and the laser resonant cavity in which the second frequency-doubling module 2 is located) through power regulation, feedback control, and coordinated tuning.

In some embodiments, a central controller determines the output powers of the two cavities (e.g., the laser resonant cavity in which the first frequency-doubling module 1 is located and the laser resonant cavity in which the second frequency-doubling module 2 is located) based on a target energy waveform. For example, a first cavity (the laser resonant cavity in which the first frequency-doubling module 1 is located) provides a baseline energy, and a second cavity (the laser resonant cavity where the second frequency-doubling module 2 is located) provides a dynamic incremental. The first cavity adjusts a pump current through a proportion integration differentiation (PID) controller to stabilize the baseline energy and/or a baseline power, and the second cavity rapidly regulates the intensity of an optical field within the cavity through an optical-electro modulator to achieve dynamic power changes. The two fundamental frequency laser beams are temporally synchronized to combined, and then pass through the frequency-doubling crystals (e.g., the first frequency-doubling crystal 104 and the second frequency-doubling crystal 204) to generate frequency-doubled pulses with a desired energy. The central controller dynamically adjusts the output powers of the two cavities based on real-time monitored frequency-doubling pulse energy to compensate for deviations.

More descriptions regarding the fundamental frequency laser and the frequency-doubled laser may be found elsewhere in the present disclosure (e.g., FIG. 5 and related descriptions thereof).

In some embodiments, the first frequency-doubling module 1 is externally connected to a first fundamental frequency laser generation module 3, and the second frequency-doubling module 2 is externally connected to a second fundamental frequency laser generation module 4. The first fundamental frequency laser generation module 3 is connected to another end of the first harmonic separation mirror 103, and the second fundamental frequency laser generation module 4 is connected to another end of the second harmonic separation mirror 203.

More descriptions regarding the first fundamental frequency laser generation module 3 and the second fundamental frequency laser generation module 4 may be found elsewhere in the present disclosure (e.g., FIG. 5 and related descriptions thereof).

In some embodiments, since the unconverted fundamental frequency laser may pass through the frequency-doubling crystal again for further conversion, the frequency-doubling efficiency is improved, resulting in more fundamental frequency laser ultimately being converted into the frequency-doubled laser. Additionally, dual-beam combining is achieved through the double-sided harmonic separation mirror 105, which improves the beam quality of the frequency-doubled laser, making the output beam more uniform and directional.

In some embodiments, the first frequency-doubling module 1 further includes a first fundamental-frequency high-reflectivity cavity mirror 101 and a first working crystal 102; and the second frequency-doubling module 2 further includes a second fundamental-frequency high-reflectivity cavity mirror 201 and a second working crystal 202. An end of the first fundamental-frequency high-reflectivity cavity mirror 101 is connected to an end to an end of the first working crystal 102; another end of the first working crystal 102 is connected to another end of the first harmonic separation mirror 103. The another end of the second harmonic separation mirror 203 is connected to an end of the second working crystal 202; and another end of the second working crystal 202 is connected to an end of the second fundamental-frequency high-reflectivity cavity mirror 201.

More descriptions regarding the first fundamental-frequency high-reflectivity cavity mirror 101, the first working crystal 102, the second fundamental-frequency high-reflectivity cavity mirror 201, and the second working crystal 202 may be found elsewhere in the present disclosure (e.g., FIG. 6 and related descriptions thereof).

In a traditional extracavity frequency-doubling system, the energy of the fundamental frequency laser may be reduced due to losses, scattering, etc., when the fundamental frequency laser passes through multiple optical elements. In some embodiments, the intracavity frequency-doubling approach of the present disclosure can reduce the energy loss of the fundamental frequency laser that transmits from the cavity to external components, thereby improving energy utilization efficiency and enhancing the stability of the laser output.

A traditional extracavity frequency-doubling scheme usually requires additional lenses, filters, and optical alignment systems to optimize the frequency-doubled laser. In the embodiments of the present disclosure, the intracavity frequency-doubling approach reduces reliance on external optical components, resulting in a more compact system and lowering the difficulty of optical alignment.

In some embodiment of the present disclosure, an end of the first harmonic separation mirror 103 is connected to an end of the first frequency-doubling crystal 104; another end of the first frequency-doubling crystal 104 is connected to another end of the double-sided harmonic separation mirror 105; another end of the double-sided harmonic separation mirror 105 is connected to an end of the second frequency-doubling crystal 204; and another end of the second frequency-doubling crystal 204 is connected to an end of the second harmonic separation mirror 203. This configuration facilitates the generation of the frequency-doubled laser with high power and high beam quality while maintaining the polarization characteristics of the laser.

In some embodiments of the present disclosure, the series configuration of two-stage frequency-doubling modules enables independent adjustment of the powers and the delays of the two pulsed laser beams, allowing real-time pulse editing.

In some embodiments of the present disclosure, the series configuration of two-stage frequency-doubling modules can improve the overall frequency conversion efficiency. Compared with single-stage frequency doubling, this configuration more fully utilizes the energy of the incident laser light and increases the output power of the frequency-doubled laser. Since the frequency-doubling process may introduce phase-matching errors and beam distortion, the two-stage frequency-doubling approach can optimize beam quality by reducing phase mismatch issues that may arise from single-pass frequency doubling, thereby improving the mode quality of the final output beam.

In some embodiments of the present disclosure, the dual-sided harmonic separation mirror 105 can more effectively separate and guide the fundamental frequency laser and the frequency-doubled laser, reduce unnecessary energy loss, and improve a light energy utilization rate of the system. As the first frequency-doubling module 1 and the second frequency-doubling module 2 are relatively independent, a crystal type, a phase matching angle, and a feature of the harmonic separation mirror may be adjusted according to different application requirements to optimize the frequency-doubling conversion efficiency at specific wavelengths.

In the embodiment of the present disclosure, the series configuration of the two-stage frequency-doubling modules enables the generation of a high-power, high-beam-quality frequency-doubled laser while preserving laser polarization characteristics.

The embodiment of the present disclosure utilizes the frequency-doubling modules (e.g., the first frequency-doubling module and the second frequency-doubling module) and the dual-sided harmonic separation mirror 105 to effectively combine the two frequency-doubled laser beams, thereby improving the output intensity and quality of the final frequency-doubled laser. Compared with a single-beam frequency-doubling system, the dual-beam combining approach more effectively utilizes the fundamental frequency laser to generate the frequency-doubled laser with a higher energy.

The dual-beam combining laser frequency-doubling device provided in the embodiments of the present disclosure can be applied to both the intracavity frequency-doubling combining and the extracavity frequency-doubling combining, offering broader applicability and greater operational flexibility.

It should be noted that the above descriptions of the dual-beam combining laser frequency-doubling device and the modules thereof are only for the convenience of descriptions, and do not limit the present disclosure to the scope of the embodiments cited. For a person skilled in the art, after understanding the principle of the dual-beam combining laser frequency-doubling device, it may be possible to arbitrarily combine individual modules or form a subsystem to connect with other modules without departing from this principle.

FIG. 2 is a schematic diagram illustrating superposition of two pulsed laser beams according to some embodiments of the present disclosure.

As shown in FIG. 2, the dual-beam combining laser frequency-doubling device controls the pulse delays of the two pulsed laser beams, maintaining synchronized pulse delay between the two pulsed laser beams to achieve pulse energy superposition, thereby enhancing the energy of a single pulse.

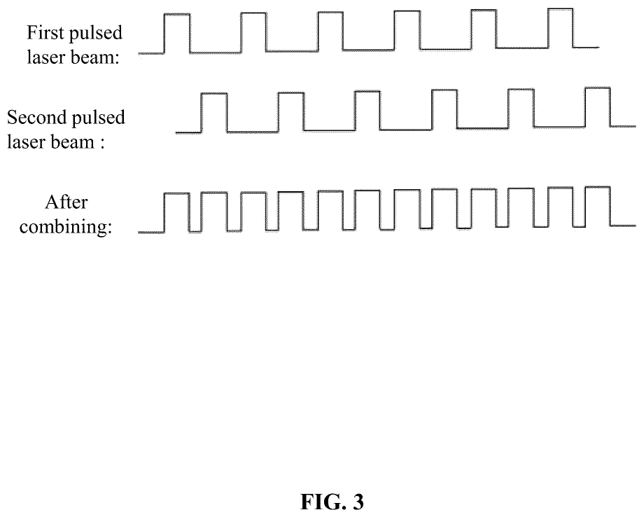

FIG. 3 is another schematic diagram illustrating superposition of two pulsed laser beams according to some embodiments of the present disclosure.

As shown in FIG. 3, the dual-beam combining laser frequency-doubling device controls the pulse delays of the two pulsed laser beams such that their pulse delays are staggered, doubling the count of pulses within a unit time, thereby increasing the repetition rate and the average power.

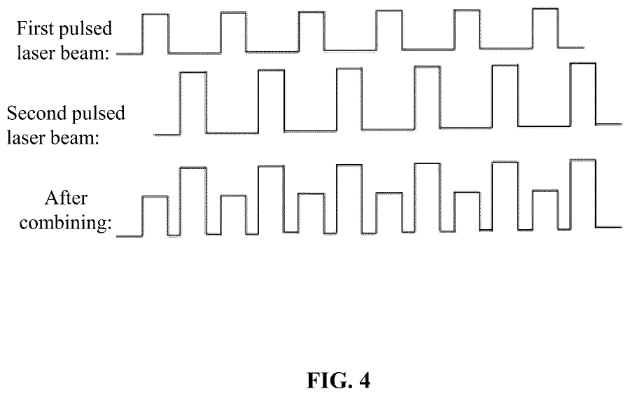

FIG. 4 is a further schematic diagram illustrating superposition of two pulsed laser beams according to some embodiments of the present disclosure.

As shown in FIG. 4, the dual-beam combining laser frequency-doubling device controls the pulse delays of the two pulsed laser beams. By adjusting the laser power of a single pulsed laser beam and the pulse delays of the two pulsed laser beams, the two pulsed laser beams can alternate in intensity, thereby achieving pulse shaping and encoding, and enabling real-time pulse energy editing.

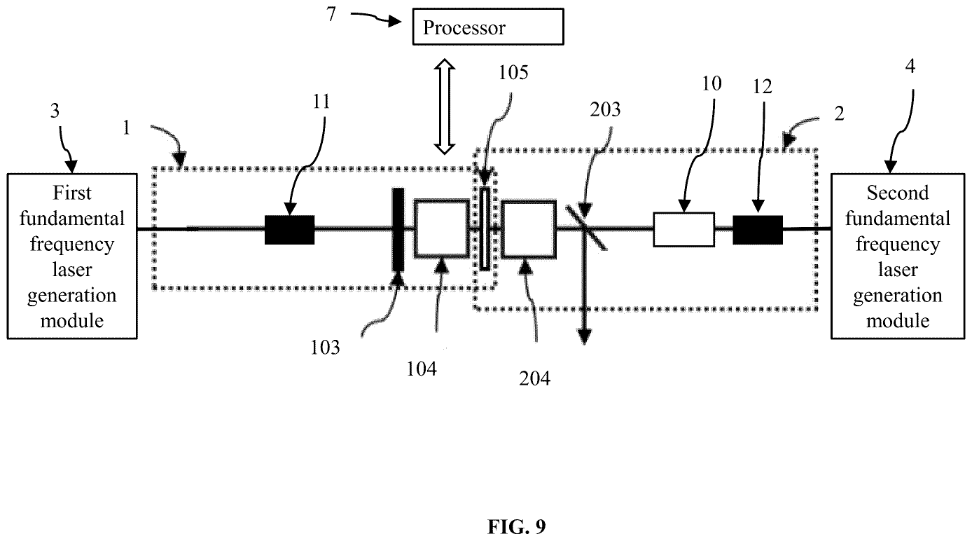

More descriptions regarding adjusting the pulse delays of the two pulses may be found elsewhere in the present disclosure (e.g., FIG. 9 and related descriptions thereof). It should be noted that FIG. 2, FIG. 3, and FIG. 4 are only one implementation manner, and other implementation manners are not described in detail.

Based on the same inventive concept, embodiments of the present disclosure further provide an extracavity frequency-doubling dual-beam combining laser frequency-doubling device. Referring to FIG. 5, FIG. 5 is a schematic diagram illustrating an exemplary structure of an extracavity frequency-doubling dual-beam combining laser frequency-doubling device according to some embodiments of the present disclosure. The extracavity frequency-doubling dual-beam combining laser frequency-doubling device includes a first frequency-doubling module 1, a second frequency-doubling module 2, a first fundamental frequency laser generation module 3, and a second fundamental frequency laser generation module 4.

In some embodiments, the first frequency-doubling module 1 and the second frequency-doubling module 2 share a dual-sided harmonic separation mirror 105. The first frequency-doubling module 1 includes a first harmonic separation mirror 103 and a first frequency-doubling crystal 104. The second frequency-doubling module 2 includes a second harmonic separation mirror 203 and a second frequency-doubling crystal 204. An end of the first harmonic separation mirror 103 is connected to an end of the first frequency-doubling crystal 104; another end of the first frequency-doubling crystal 104 is connected to an end of the dual-sided harmonic separation mirror 105; another end of the dual-sided harmonic separation mirror 105 is connected to an end of the second frequency-doubling crystal 204; another end of the second frequency-doubling crystal 204 is connected to an end of the second harmonic separation mirror 203. The first frequency-doubling module 1 is externally connected to the first fundamental frequency laser generation module 3, and the second frequency-doubling module 2 is externally connected to the second fundamental frequency laser generation module 4. The first fundamental frequency laser generation module 3 is connected to another end of the first harmonic separation mirror 103, and the second fundamental frequency laser generation module 4 is connected to another end of the second harmonic separation mirror 203.

In some embodiments, for the extracavity frequency-doubling dual-beam combining laser frequency-doubling device, the first harmonic separation mirror 103 and the second harmonic separation mirror 203 are mirrors with high transmittance for the fundamental frequency laser and highly reflectivity for the frequency-doubled laser. The first harmonic separation mirror 103 is coated for an incidence angle of 0°. The second harmonic separation mirror 203 is configured to output the frequency-doubled laser after beam-combining. The second harmonic separation mirror 203 is provided with an angled coating according to application requirements, which is determined by technical personnel. The first frequency-doubling crystal 104 and the second frequency-doubling crystal 204 are frequency-doubling crystals for converting the fundamental frequency laser into the frequency-doubled laser. The dual-sided harmonic separation mirror 105 is an optical element shared by the first frequency-doubling module 1 and the second frequency-doubling module 2. The dual-sided harmonic separation mirror 105 is coated on two sides and the dual-sided harmonic separation mirror 105 reflects the fundamental frequency laser and transmits the frequency-doubled laser.

In some embodiments, the first fundamental frequency laser generation module 3 generates the fundamental frequency laser (i.e., a first target fundamental frequency laser). The first target fundamental frequency laser passes through the first harmonic separation mirror 103 and then enters the first frequency-doubling crystal 104. After the first target fundamental frequency laser enters the first frequency-doubling crystal 104, frequency-doubling is performed on the first target fundamental frequency laser to generate the frequency-doubled laser (i.e., the first target frequency-doubled laser is frequency-doubled laser generated after the frequency-doubling is performed on the first target fundamental frequency laser). The generated first target frequency-doubled laser sequentially passes through the dual-sided harmonic separation mirror 105 and the second frequency-doubling crystal 204, and is reflected and output by the second harmonic separation mirror 203.

In some embodiments, the first target fundamental frequency laser enters the first frequency-doubling crystal 104 to generate fundamental frequency laser (i.e., a first non-frequency-doubled fundamental frequency laser) that is undoubled. The first non-frequency-doubled fundamental frequency laser is reflected by the double-sided harmonic separation mirror 105 and passes through the first frequency-doubling crystal 104 again, generating a frequency-doubled laser again. The newly generated frequency-doubled laser is reflected by the first harmonic separation mirror 103, then transmitted through the first frequency-doubling crystal 104, the double-sided harmonic separation mirror 105, and the second frequency-doubling crystal 204, before being reflected and output by the second harmonic separation mirror 203.

The first fundamental frequency laser generation module 3 refers to a laser source or a laser system that provides an original fundamental frequency laser for the laser frequency-doubling device. In some embodiments, the first fundamental frequency laser generation module 3 may include a fiber laser, a semiconductor laser, a solid-state laser, or the like.

The first target fundamental frequency laser refers to an original input light wave during a laser frequency-doubling process. The first target fundamental frequency laser may be converted into a light wave with a higher frequency (or a shorter wavelength) through a nonlinear optical effect (e.g., frequency-doubling, sum frequency generation, difference frequency generation, etc.). For example, after the frequency-doubling is perform on first target fundamental frequency laser with a wavelength of 1550 nm, a first target frequency-doubled laser with a wavelength of 775 nm may be generated.

The first target frequency-doubled laser refers to a new light wave generated by doubling the frequency or halving the wavelength of the first target fundamental frequency laser through a second-order nonlinear effect of a nonlinear crystal during the laser frequency-doubling process. The frequency of the first target frequency-doubled laser is twice the frequency of the first target fundamental frequency laser, and the wavelength is half the wavelength of the first target fundamental frequency laser.

In some embodiments, the second fundamental frequency laser generation module 4 generates a fundamental frequency laser (i.e., a second target fundamental frequency laser). The second target fundamental frequency laser passes through the second harmonic separation mirror 203 and enters the second frequency-doubling crystal 204. After the second target fundamental frequency laser enters the second frequency-doubling crystal 204, the frequency-doubling is performed to generate a frequency-doubled laser (i.e., a second target frequency-doubled laser, which is a frequency-doubled laser generated after the frequency-doubling is performed on the second target fundamental frequency laser). The second target frequency-doubled laser sequentially passes through the dual-sided harmonic separation mirror 105 and the first frequency-doubling crystal 104, and is reflected by the first harmonic separation mirror 103. The reflected second target frequency-doubled laser sequentially passes through the first frequency-doubling crystal 104, the dual-sided harmonic separation mirror 105, and the second frequency-doubling crystal 204, and is reflected and output by the second harmonic separation mirror 203.

The second fundamental frequency laser generation module 4, the second target fundamental frequency laser, and the second target frequency-doubled laser are similar to the first fundamental frequency laser generation module 3, the first target fundamental frequency laser, and the first target frequency-doubled laser. More descriptions regarding the second fundamental frequency laser generation module 4, the second target fundamental frequency laser, and the second target frequency-doubled laser may be found elsewhere in the present disclosure (e.g., descriptions relating to the first fundamental frequency laser generation module 3, the first target fundamental frequency laser, and the first target frequency-doubled laser).

The embodiments of the present disclosure significantly improve the conversion efficiency of the frequency-doubled laser by configuring the first frequency-doubling module 1, the second frequency-doubling module 2, the first fundamental frequency laser generation module 3, and the second fundamental frequency laser generation module 4, enabling the fundamental frequency laser to pass through the frequency-doubling crystals (e.g., the first frequency-doubling crystal 104 and the second frequency-doubling crystal 204) multiple times. Through optical path circulation, the dual-beam combining laser frequency-doubling device provided in the embodiments of the present disclosure can more precisely meet phase-matching requirements, ensuring highly efficient conversion.

In some embodiments, after the second target fundamental frequency laser enters the second frequency-doubling crystal 204, the frequency-doubling is performed to obtain a first residual fundamental frequency laser. The first residual fundamental frequency laser is a portion of the second target fundamental frequency laser that is undoubled. After the first residual fundamental frequency laser is reflected by the dual-sided harmonic separation mirror 105 and re-enters the second frequency-doubling crystal 204, the frequency-doubling is performed to obtain a first residual frequency-doubled laser. The first residual frequency-doubled laser is reflected and output by the second harmonic separation mirror 203.

For the second target fundamental frequency laser generated by the second fundamental frequency laser generation module 4, its transmission and reflection between the first harmonic separation mirror 103 and the second harmonic separation mirror 203 essentially produce four output paths of the frequency-doubled laser. However, due to the extremely short optical path differences, there is no temporal separation of the laser pulses for pulsed lasers.

The first residual fundamental frequency laser refers to a portion of the fundamental frequency laser that, after passing through the nonlinear crystal during the laser frequency-doubling process, is not completely converted into the frequency-doubled laser or lasers of other frequencies. In some embodiments, if a periodically poled structure of the frequency-doubling crystal is imperfect, or if there is a mismatch between a pulse width of the fundamental frequency laser and a response of the frequency-doubling crystal, a portion of the fundamental frequency laser (e.g., the second target fundamental frequency laser) may remain unconverted.

The first residual frequency-doubled laser refers to a frequency-doubled laser generated by re-frequency-doubling of the residual fundamental frequency laser that is not completely converted during the laser frequency doubling process after passing through the nonlinear crystal. For example, assume that a second target fundamental frequency laser has a wavelength of 1319 nm and is frequency-doubled to generate a second target frequency-doubled laser with a wavelength of 658 nm. If the initial frequency doubling efficiency is 80%, then 20% of the second target fundamental frequency laser with the wavelength of 1319 nm remains as the first residual fundamental frequency laser and be reflected. When the 20% portion of the second target fundamental frequency laser with the wavelength of 1319 nm re-enters the frequency-doubling crystal (e.g., the second frequency-doubling crystal 204), it may generate a new 658 nm first residual frequency-doubled laser.

In some embodiments of the present disclosure, by providing the first frequency-doubling module 1, the second frequency-doubling module 2, the first fundamental frequency laser generation module 3, and the second fundamental frequency laser generation module 4, the residual fundamental frequency laser that is not frequency-doubled can re-enter the frequency-doubling crystal to undergo frequency-doubling again, thereby generating the residual frequency-doubled laser. This realizes the circulation of the residual fundamental frequency laser, significantly improving the frequency-doubling conversion efficiency of the dual-beam combining laser frequency-doubling device and reducing energy loss. In addition, through multiple rounds of frequency-doubling, the dual-beam combining laser frequency-doubling device described in the embodiments of the present disclosure can cumulatively generate more frequency-doubled lasers, thereby improving output efficiency and enhancing spectral stability.

Based on the same inventive concepts, embodiments of the present disclosure further provide an intracavity frequency-doubling dual-beam combining laser frequency-doubling device. Referring to FIG. 6, FIG. 6 is a schematic diagram illustrating an exemplary structure of an intracavity frequency-doubling dual-beam combining laser frequency-doubling device according to some embodiments of the present disclosure. The intracavity frequency-doubling dual-beam combining laser frequency-doubling device (also referred to as the intracavity frequency-doubling laser frequency-doubling device for brevity) includes a first frequency-doubling module 1 and a second frequency-doubling module 2.

In some embodiments, the first frequency-doubling module 1 and the second frequency-doubling module 2 share a dual-sided harmonic separation mirror 105. For example, the dual-sided harmonic separation mirror 105 may be arranged between the first frequency-doubling module 1 and the second frequency-doubling module 2.

In some embodiments, compared with the extracavity frequency-doubling dual-beam combining laser frequency-doubling device, the intracavity frequency-doubling dual-beam combining laser frequency-doubling device further includes a first fundamental-frequency high-reflectivity cavity mirror 101 and a second fundamental-frequency high-reflectivity cavity mirror 201.

The first fundamental-frequency high-reflectivity cavity mirror 101 and the second fundamental-frequency high-reflectivity cavity mirror 201 are cavity mirrors having high reflectivity for the fundamental frequency laser, and are configured to reflect the fundamental frequency laser. The intracavity frequency-doubling dual-beam combining laser frequency-doubling device further includes a first working crystal 102 and a second working crystal 202. The first working crystal 102 and the second working crystal 202 are working crystals for generating the fundamental frequency laser, and when the fundamental frequency laser passes through the first working crystal 102 or the second working crystal 202, the fundamental frequency laser is enhanced by the first working crystal 102 or the second working crystal 202. More descriptions regarding the first fundamental-frequency high-reflectivity cavity mirror 101, the second fundamental-frequency high-reflectivity cavity mirror 201, the first working crystal 102, and the second working crystal 202 may be found in the related descriptions below.

In some embodiments, the first frequency-doubling module 1 further includes the first fundamental-frequency high-reflectivity cavity mirror 101 and the first working crystal 102, and the second frequency-doubling module 2 further includes the second fundamental-frequency high-reflectivity cavity mirror 201 and the second working crystal 202. An end of the first fundamental-frequency high-reflectivity cavity mirror 101 is connected to an end of the first working crystal 102, and another end of the first working crystal 102 is connected to another end of the first harmonic separation mirror 103. Another end of the second harmonic separation mirror 203is connected to an end of the second working crystal 202, and another end of the second working crystal 202 is connected to an end of the second fundamental-frequency high-reflectivity cavity mirror 201.

In some embodiments, the first frequency-doubling module 1 includes the first fundamental-frequency high-reflectivity cavity mirror 101, the first working crystal 102, the first harmonic separation mirror 103, and the first frequency-doubling crystal 104. The second frequency-doubling module 2 includes the second fundamental-frequency high-reflectivity cavity mirror 201, the second working crystal 202, the second harmonic separation mirror 203, and the second frequency-doubling crystal 204. An end of the first fundamental-frequency high-reflectivity cavity mirror 101 is connected to an end of the first working crystal 102. Another end of the first working crystal 102 is connected to another end of the first harmonic separation mirror 103. An end of the first harmonic separation mirror 103 is connected to an end of the first frequency-doubling crystal 104. Another end of the first frequency-doubling crystal 104 is connected to an end of the dual-sided harmonic separation mirror 105. Another end of the second harmonic separation mirror 203 is connected to an end of the second working crystal 202. Another end of the second working crystal 202 is connected to an end of the second fundamental-frequency high-reflectivity cavity mirror 201. Another end of the dual-sided harmonic separation mirror 105 is connected to an end of the second frequency-doubling crystal 204. Another end of the second frequency-doubling crystal 204 is connected to an end of the second harmonic separation mirror 203.

The first fundamental-frequency high-reflectivity cavity mirror 101 refers to an optical cavity mirror with high reflectivity for the fundamental frequency laser. In some embodiments, the first fundamental-frequency high-reflectivity cavity mirror 101 is used to construct a laser resonant cavity structure, enabling the fundamental frequency laser to make multiple round trips within the cavity through the frequency-doubling crystals (e.g., the first frequency-doubling crystal 104 and the second frequency-doubling crystal 204), thereby increasing an interaction duration and a count of interactions between the fundamental frequency laser and the frequency-doubling crystals, and improving the frequency-doubling conversion efficiency.

The first working crystal 102 refers to a crystal that may be excited by a pump source (e.g., a laser diode) to output a laser with a specific wavelength. The first working crystal 102 is configured to reshape, focus, and amplify the residual fundamental frequency laser (i.e., a portion of the fundamental frequency laser that is undoubled), or perform mode field shaping and phase correction on the residual fundamental frequency laser, thereby repeatedly enhancing the residual fundamental frequency laser (e.g., enhancing a local intensity or an overall power of the residual fundamental frequency laser).

In some embodiments, the first working crystal 102 may include a Nd:YAG crystal, a Nd:YVO4 crystal, a Nd:GdVO4 crystal, a Yb:YAG crystal, a Tm:YAG crystal, a Ho:YAG crystal, or the like.

In some embodiments, the first working crystal 102 generates a fundamental frequency laser (i.e., a third target fundamental frequency laser). The third target fundamental frequency laser passes through the first harmonic separation mirror 103 and then enters the first frequency-doubling crystal 104. After the third target fundamental frequency laser enters the first frequency-doubling crystal 104, the frequency-doubling is performed to generate a frequency-doubled laser (i.e., a third target frequency-doubled laser, which is a frequency-doubled laser generated after the frequency-doubling is performed on the third target fundamental frequency laser). The generated third target frequency-doubled laser transmits through the dual-sided harmonic separation mirror 105 and/or the second frequency-doubling crystal 204, and is reflected and output by the second harmonic separation mirror 203.

In some embodiments, after the third target fundamental frequency laser enters the first frequency-doubling crystal 104, the following steps are performed. S1, after the third target fundamental frequency laser enters the first frequency-doubling crystal 104, the frequency-doubling is performed to obtain a second residual fundamental frequency laser. The second residual fundamental frequency laser is a portion of the third target fundamental frequency laser that is undoubled. S2, the second residual fundamental frequency laser is reflected by the dual-sided harmonic separation mirror 105 and re-enters the first frequency-doubling crystal 104, the frequency-doubling is performed to obtain a portion of the second residual fundamental frequency laser that is undoubled (i.e., a third residual fundamental frequency laser). S3, the third residual fundamental frequency laser passes through the first harmonic separation mirror 103, and passes through the first working crystal 102 for fundamental frequency laser enhancement to obtain a first enhanced fundamental frequency laser. S4, the first enhanced fundamental frequency laser is reflected by the first fundamental-frequency high-reflectivity cavity mirror 101, and passes through the first working crystal 102 for further fundamental frequency laser enhancement to obtain a second enhanced fundamental frequency laser. S5, the second enhanced fundamental frequency laser passes through the first harmonic separation mirrors 103 and enters the first frequency-doubling crystal 104, the frequency-doubling is performed to obtain a fourth target frequency-doubled laser (i.e., a frequency-doubled laser generated after the frequency-doubling is performed on the second enhanced fundamental frequency laser) and a portion of the second enhanced fundamental frequency laser that is undoubled (i.e., a first non-enhanced fundamental frequency laser). The first non-enhanced fundamental frequency laser is designated as the second residual fundamental frequency laser, the second residual fundamental frequency laser returns to S2 to repeat the processing cycle, continuing intracavity oscillation. S6, the fourth target frequency-doubled laser passes through the dual-sided harmonic separation mirror 105 and/or the second frequency-doubling crystal 204 and is reflected and output by the second harmonic separation mirror 203.

In some embodiments, the second residual fundamental frequency laser is reflected by the double-sided harmonic separation mirror 105 and re-enters the first frequency doubling crystal 104, where it undergoes frequency doubling again to generate a frequency-doubled laser (i.e., a frequency-doubled second residual fundamental frequency laser). The newly generated frequency-doubled laser (i.e., the frequency-doubled second residual fundamental frequency laser) is then reflected by the first harmonic separation mirror 103, and passes through the first frequency doubling crystal 104 again, the double-sided harmonic separation mirror 106, and the second frequency doubling crystal 204, and is ultimately reflected and output by the second harmonic separation mirror 203.

The enhanced fundamental frequency laser (e.g., the first enhanced fundamental frequency laser and the second enhanced fundamental frequency laser) refers to a fundamental frequency laser generated by reshaping, focusing, and amplifying the residual fundamental frequency laser (i.e., a portion of the fundamental frequency laser that is not completely converted after the initial frequency-doubling), or by performing mode field reshaping and phase correction on the residual fundamental frequency laser, through an optical structure or a nonlinear crystal (e.g., the first working crystal 102 and the second working crystal 202).

In some embodiments of the present disclosure, by further providing the first fundamental-frequency high-reflectivity cavity mirror 101, the first working crystal 102, the second fundamental-frequency high-reflectivity cavity mirror 201, and the second working crystal 202, the residual fundamental frequency laser (i.e., the portion of the fundamental frequency laser that is not completely converted) can be enhanced by passing through the first working crystal 102 and the second working crystal 202, and can repeatedly participate in the frequency-doubling process of the fundamental frequency laser, thereby improving the overall frequency doubling conversion efficiency and reducing the amount of residual fundamental frequency laser.

In some embodiments of the present disclosure, an optical path is provided from the first working crystal 102 to the second harmonic separation mirror 203, such that the fundamental frequency laser generated by the first working crystal 102 undergoes the frequency-doubling in the first frequency doubling crystal 104 to generate a frequency-doubled laser, and the frequency-doubled laser passes through the second frequency doubling crystal 204 and is reflected and output by the second harmonic separation mirror 203. This configuration realizes the synergistic effect between the two-stage frequency doubling crystals and the harmonic separation mirrors, optimizes beam quality, and improves frequency-doubling efficiency.

The second fundamental-frequency high-reflectivity cavity mirror 201 is similar to the first fundamental-frequency high-reflectivity cavity mirror 101. More descriptions regarding the second fundamental-frequency high-reflectivity cavity mirror 201 may be found elsewhere in the present disclosure (e.g., the first fundamental-frequency high-reflectivity cavity mirror 101 and related descriptions thereof).

The second working crystal 202 is similar to the first working crystal 102. More descriptions regarding the second working crystal 202 may be found elsewhere in the present disclosure (e.g., descriptions relating to the first working crystal 102).

In some embodiments, the second working crystal 202 generates a fundamental frequency laser (i.e., a fourth target fundamental frequency laser). The fourth target fundamental frequency laser passes through the second harmonic separation mirror 203 and enters the second frequency-doubling crystal 204. After the fourth target fundamental frequency laser enters the second frequency-doubling crystal 204, the frequency-doubling is performed to generate a frequency-doubled laser (i.e., a fifth target frequency-doubled laser, which is a frequency-doubled laser generated after the frequency-doubling is performed on the fourth target fundamental frequency laser). The generated fifth target frequency-doubled laser sequentially passes through the dual-sided harmonic separation mirror 105 and the first frequency-doubling crystal 104, and is reflected by the first harmonic separation mirrors 103. The reflected fifth target frequency-doubled laser again sequentially passes through the first frequency-doubling crystal 104, the dual-sided harmonic separation mirror 105, and the second frequency-doubling crystal 204, and is reflected and output by the second harmonic separation mirror 203.

In some embodiments, after the fourth target fundamental frequency laser enters the second frequency-doubling crystal 204, the following steps are performed. Step 1. the fourth target fundamental frequency laser enters the second frequency-doubling crystal 204, the frequency-doubling is performed to obtain a fourth residual fundamental frequency laser, the fourth residual fundamental frequency laser is a portion of the fourth target fundamental frequency laser that is undoubled. Step 2, the fourth residual fundamental frequency laser is reflected by the dual-sided harmonic separation mirror 105 and re-enters the second frequency-doubling crystal 204, the frequency-doubling is performed to obtain a portion of the fourth residual fundamental frequency laser that is undoubled (i.e., a fifth residual fundamental frequency laser). Step 3, the fifth residual fundamental frequency laser passes through the second harmonic separation mirror 203, and passes through the second working crystal 202 for fundamental frequency laser enhancement to obtain a third enhanced fundamental frequency laser. Step 4, the third enhanced fundamental frequency laser is reflected by the second fundamental-frequency high-reflectivity cavity mirror 201, and passes again through the second working crystal 202 for further fundamental frequency laser enhancement to obtain a fourth enhanced fundamental frequency laser. Step 5, the fourth enhanced fundamental frequency laser passes through the second harmonic separation mirror 203 and enters the second frequency-doubling crystal 204, the frequency-doubling is performed to obtain a sixth target frequency-doubled laser (a portion of the fourth enhanced fundamental frequency laser that is subjected to the frequency-doubling) and a portion of the fourth enhanced fundamental frequency laser that is undoubled (a second non-enhanced fundamental frequency laser). Step 6, the sixth target frequency-doubled laser sequentially passes through the dual-sided harmonic separation mirror 105 and the first frequency-doubling crystal 104, is reflected by the first harmonic separation mirror 103, then passes again through the first frequency-doubling crystal 104, the dual-sided harmonic separation mirror 105, and the second frequency-doubling crystal 204, and is reflected and output by the second harmonic separation mirror 203.

In some embodiments, the fourth residual fundamental frequency laser is reflected by the dual-sided harmonic separation mirror 105 and then passes again through the second frequency-doubling crystal 204, where the frequency-doubling is performed to re-generate a frequency-doubled laser (i.e., a portion of the fourth residual fundamental frequency laser that is subjected to the frequency-doubling). The re-generated frequency-doubled laser (i.e., a portion of the fourth residual fundamental frequency laser that is subjected to the frequency-doubling) is reflected and output by the second harmonic separation mirror 203. The second non-enhanced fundamental frequency laser re-executes the process of the fourth residual fundamental frequency laser to continue oscillating in the cavity.

In the embodiments of the present disclosure, during an intracavity circulation process, the unconverted fundamental frequency laser can be continuously enhanced and re-enter the frequency-doubling crystal, thereby improving the frequency-doubling conversion efficiency. Compared with external-cavity frequency doubling, the fundamental frequency laser is not wasted due to a single unsuccessful conversion attempt, but can continue to oscillate within the cavity for multiple attempts, increasing the success rate of frequency-doubling. As the fundamental frequency laser undergoes multiple reflections and enhancements within the cavity, the power of the fundamental frequency laser entering the frequency-doubling crystal becomes higher, consequently increasing the output power of the frequency-doubled laser and contributing to enhanced final energy output of the frequency-doubled laser.

In some embodiments of the present disclosure, by configuring an optical path from the second working crystal 202 to the second harmonic separation mirror 203, the fundamental frequency laser generated by the second working crystal 202 is frequency-doubled by the second frequency-doubling crystal 204 to produce a frequency-doubled laser. The frequency-doubled laser sequentially passes through the double-sided harmonic separation mirror 105 and the first frequency-doubling crystal 104, is reflected by the first harmonic separation mirror 103, then sequentially passes through the first frequency-doubling crystal 104, the double-sided harmonic separation mirror 105, and the second frequency-doubling crystal 204 again, and is finally reflected and output by the second harmonic separation mirror 203. This configuration forms a closed-loop or partially recirculating optical path, prolongs the interaction between the light beam and the crystals, achieves synergistic effects between the two-stage frequency-doubling crystals and harmonic separation mirrors, optimizes beam quality, improves frequency-doubling efficiency, and maximizes energy conversion.

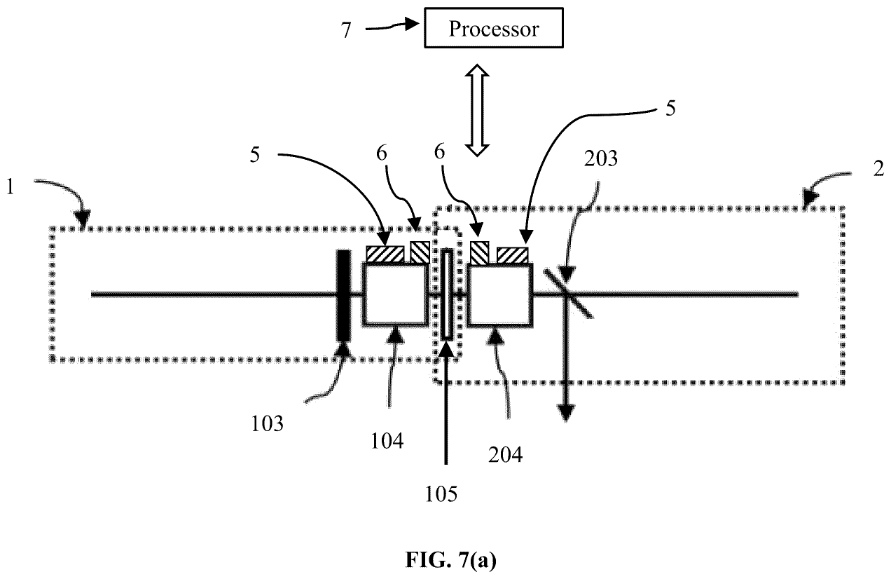

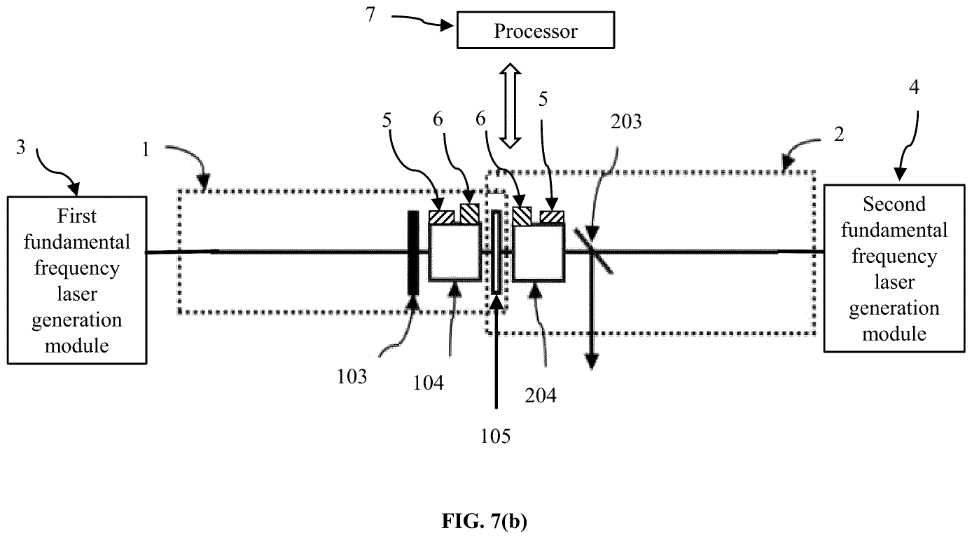

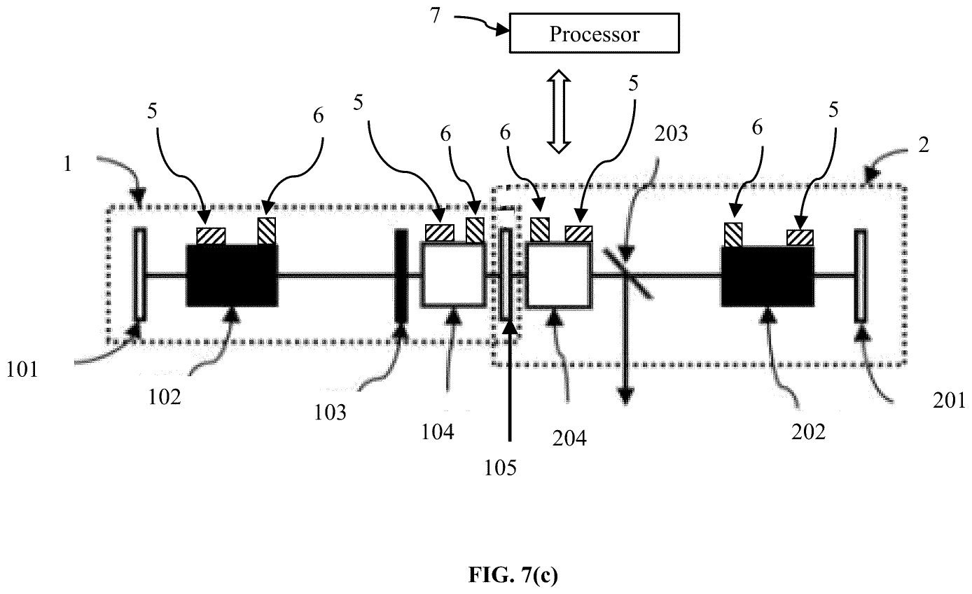

FIG. 7(a) is a schematic diagram illustrating an exemplary structure of a dual-beam combining laser frequency-doubling device according to some embodiments of the present disclosure. FIG. 7(b) is a schematic diagram illustrating an exemplary structure of a dual-beam combining laser frequency-doubling device according to some embodiments of the present disclosure. FIG. 7(c) is a schematic diagram illustrating an exemplary structure of a dual-beam combining laser frequency-doubling device according to some embodiments of the present disclosure.

In some embodiments, the dual-beam combining laser frequency-doubling device further includes a temperature sensor 5, a thermoelectric cooler (TEC) 6, and a processor 7. The temperature sensor 5 is deployed on or near surfaces of frequency-doubling crystals (e.g., the first frequency-doubling crystal 104 and the second frequency-doubling crystal 204) and/or working crystals (e.g., the first working crystal 102 and the second working crystal 202). The TEC 6 is arranged in close contact with the frequency-doubling crystals (e.g., the first frequency-doubling crystal 104 and the second frequency-doubling crystal 204) and/or the working crystals (e.g., the first working crystal 102 and the second working crystal 202).

The temperature sensor 5 is configured to measure, monitor, and convert temperature information into transferable temperature data. In some embodiments, the temperature sensor 5 may be a contact temperature sensor, e.g., the temperature sensor 5 may be a thermocouple, a resistance temperature detector (RTD), a thermistor, or the like.

In some embodiments, the temperature sensor 5 is configured to collect temperature data from the frequency-doubling crystals (e.g., the first frequency-doubling crystal 104 and the second frequency-doubling crystal 204) and/or the working crystals (e.g., the first working crystal 102 and the second working crystal 202).

The temperature sensor 5 may be a high-precision (e.g., with an accuracy of +0.1° C.) temperature sensor, e.g., the temperature sensor 5 may be a PT100 platinum resistor, an infrared thermometer for real-time monitoring the temperature data (e.g., a temperature value and a temperature variation) of the frequency-doubling crystals (e.g., the first frequency-doubling crystal 104 and the second frequency-doubling crystal 204) and/or the working crystals (e.g., the first working crystal 102 and the second working crystal 202).

The TEC 6 is a Peltier-effect-based energy conversion device utilizing a semiconductor material for cooling or heating. By controlling a drive current, the TEC 6 may switch between a cooling mode and a heating mode to achieve temperature regulation.

In some embodiments, the TEC 6 includes a semiconductor thermoelectric cooling module (e.g., TEC1-12706) composed of a plurality of N-type and P-type semiconductor elements connected in series via metal electrodes. In some embodiments, the TEC 6 may be disposed close to the frequency-doubling crystals (e.g., the first frequency-doubling crystal 104 and the second frequency-doubling crystal 204) and/or the working crystals (e.g., the first working crystal 102 and the second working crystal 202) through silicone thermal grease or a thermal interface material.

In some embodiments, by controlling the drive current of the TEC 6, the temperature of the frequency-doubling crystals (e.g., the first frequency-doubling crystal 104 and the second frequency-doubling crystal 204) and/or the temperature of the working crystals (e.g., the first working crystal 102 and the second working crystal 202) can be controlled.

The processor 7 is configured to execute instructions, process data, etc. The processor 7 may include modules such as an arithmetic unit, a controller, a register, cache memory, or the like. In some embodiments, the processor 7 is configured to determine a temperature control parameter based on the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202) collected by the temperature sensors 5, and transmit the temperature control parameter to the thermoelectric cooler 6. The processor 7 is further configured to adjust the temperature of the frequency-doubling crystals (e.g., the first frequency-doubling crystal 104 and the second frequency-doubling crystal 204) and/or the temperature of the working crystals (e.g., the first working crystal 102 and the second working crystal 202) through the TEC 6.

The temperature control parameter refers to a parameter used to set, regulate, or optimize a crystal temperature control process. In some embodiments, the temperature control parameter may include the drive current (e.g., a magnitude of the drive current) of the TEC 6. For example, the temperature control parameter may include drive currents corresponding to a plurality of temperature sampling cycles. A temperature sampling cycle refers to a period during which the temperature sensor 5 collects the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202).

In some embodiments, the processor 7 may determine, based on temperature data of the frequency-doubling crystals (e.g., the first frequency-doubling crystal 104 and the second frequency-doubling crystal 204) and/or temperature data of the working crystals (e.g., the first working crystal 102 and the second working crystal 202) collected by the temperature sensor 5, the temperature control parameter by looking up a first preset table. The first preset table includes a correspondence between the temperature data, a preset crystal temperature, and the temperature control parameter, e.g., {index 1 (temperature data) and index 2 (preset crystal temperature)→query result (temperature control parameter-drive current)}. The preset crystal temperature may be a standard temperature configured during crystal manufacturing. The first preset table may be constructed based on data collected by experiments.

In some embodiments, the processor 7 may determine, based on the temperature data of the frequency-doubling crystals (e.g., the first frequency-doubling crystal 104 and the second frequency-doubling crystal 204) and/or the working crystals (e.g., the first working crystal 102 and the second working crystal 202) collected by the temperature sensor 5, the temperature control parameter via a PID controller.

For example, the processor 7 may determine a difference between the temperature data of each of the plurality of temperature sampling cycles and the preset crystal temperature to obtain a plurality of temperature differences, and determine a temperature difference variation based on the plurality of temperature differences. The temperature difference variation refers to a change amount of the temperature differences between two adjacent temperature sampling cycles. For example, assume that the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202) collected during a first temperature sampling cycle T₁ is 25° C., the temperature data of the frequency-doubling crystals (e.g., the first frequency-doubling crystal 104 and the second frequency-doubling crystal204) and/or the temperature data of the working crystals (e.g., the first working crystal 102 and the second working crystal 202) collected during a second temperature sampling cycle T₂ is 27° C. If the preset crystal temperature is 20° C., then the temperature difference of the first temperature sampling cycle T₁ is 5° C., the temperature difference of the second temperature sampling cycle T₂ is 7° C., and the temperature difference variation between the two adjacent temperature sampling cycles T₁ and T₂ is 2° C. The processor 7 may designate the temperature differences of the plurality of temperature sampling cycles, the temperature sampling cycles, and the temperature difference variations of the plurality of temperature sampling cycles as inputs to the PID controller, and output the drive current through the PID controller.

In some embodiments, the processor 7 may send the temperature control parameter (e.g., the drive current) to the TEC 6 through serial communication, a general Input/Output (I/O) interface, an analog-to-digital converter/digital-to-analog converter (ADC/DAC) interface, etc. The TEC 6 adjusts the temperature of the frequency-doubling crystals (e.g., the first frequency-doubling crystal 104 and the second frequency-doubling crystal 204) and/or the temperature of the working crystals (e.g., the first working crystal 102 and the second working crystal 202) based on the temperature control parameter (e.g., the drive current).

In some embodiments, the processor 7 is further configured to determine the temperature control parameter via a first vector database based on the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202), the preset crystal temperature, crystal feature data, and TEC feature data.

The crystal feature data may include a material type (e.g., crystal composition), a shape and a size of the crystal, a thermal expansion coefficient, or the like. The TEC feature data may include a figure of merit, a thermal conductivity, an electrical conductivity, a thermal expansion coefficient, or the like. The vector database refers to a database for storing, indexing, and querying vectors. By using the vector database, large-scale vector similarity search and other vector-based operations can be efficiently performed.

In some embodiments, the processor 7 may conduct experiments under different experimental conditions (e.g., different crystal types and different TEC types) to obtain reference temperature data, reference crystal feature data, and reference TEC feature data, and construct a plurality of reference temperature feature vectors based on the reference temperature data, the preset crystal temperature, the reference crystal feature data, and the reference TEC feature data. Each of the reference temperature feature vectors corresponds to a temperature vector label. The temperature vector label may be a reference temperature control parameter (e.g., a reference drive current) for adjusting the temperature data of the frequency-doubling crystal and/or the temperature data of the working crystal to the preset crystal temperature under a corresponding experimental condition. The processor 7 may store the plurality of reference temperature feature vectors and the corresponding reference temperature control parameters (e.g., reference drive currents) in the first vector database (e.g., Milvus or Faiss).

The processor 7 may construct a temperature feature vector to be matched based on the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202), the preset crystal temperature, the crystal feature data, and the TEC feature data. The processor 7 may determine a similarity (e.g., a Euclidean distance or a cosine similarity) between the temperature feature vector to be matched and each of the plurality of temperature vector labels, and designate the temperature vector label of the reference temperature feature vector with the highest similarity as the temperature control parameter (e.g., the drive current).

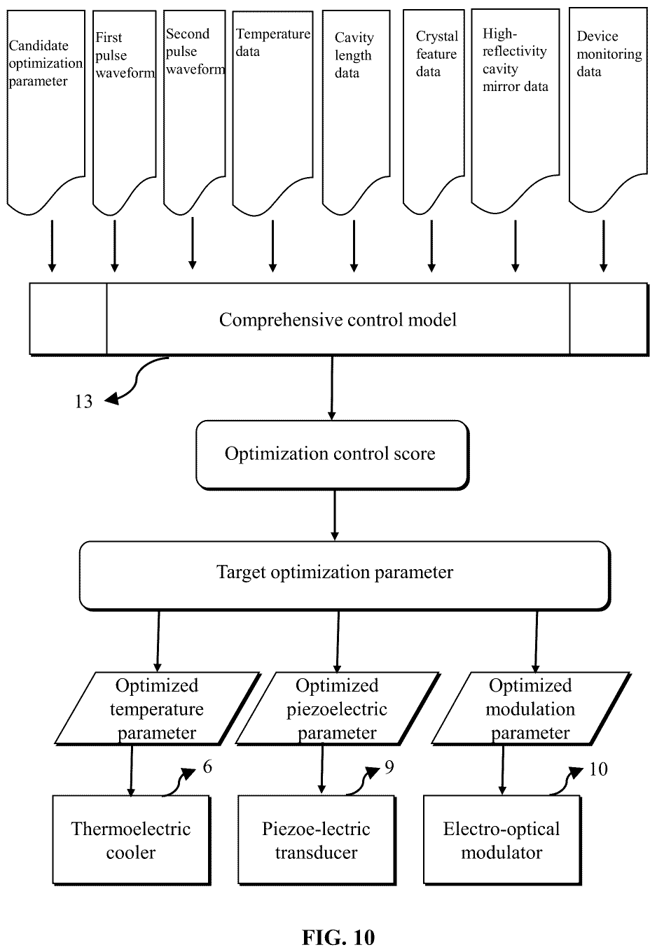

More descriptions regarding the temperature control parameter may be found elsewhere in the present disclosure (e.g., FIG. 10 and related descriptions thereof).

The embodiments of the present disclosure determine the temperature control parameter by using the first vector database based on the temperature data of the frequency-doubling crystals (e.g., the first frequency-doubling crystal 104 and the second frequency-doubling crystal 204) and/or the temperature data of working crystals (e.g., the first working crystal 102 and the second working crystal 202), the preset crystal temperature, the crystal feature data, and the TEC feature data, taking into account the different responses of different types of crystals to temperature variations. In addition, taking into account the crystal feature data can better adapt to different crystal materials, making the dual-beam combining laser frequency-doubling device more versatile and flexible, thereby achieving more accurate crystal temperature control, and making the dual-beam combining laser frequency-doubling device applicable to a wider variety of application scenarios. Under conditions where environmental conditions are changeable or high precision is required, the embodiments of the present disclosure may construct the temperature feature vector and employ the first vector database to query the optimal drive current to quickly respond to and adjust the temperature of the frequency-doubling crystal and/or the temperature of the working crystal, thereby ensuring that the dual-beam combining laser frequency-doubling device constantly remains in an optimal working state.

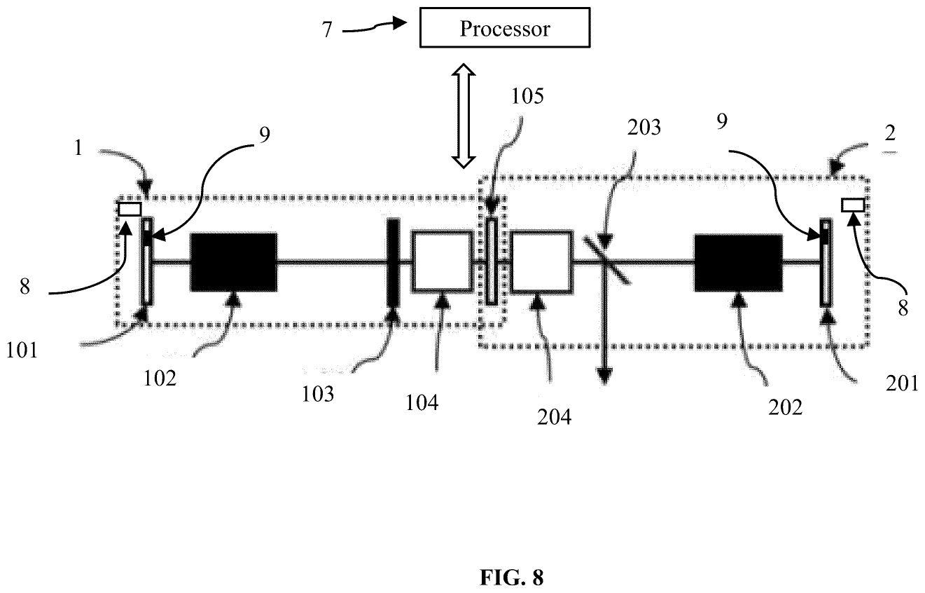

In some embodiments, the dual-beam combining laser frequency-doubling device further includes a displacement sensor and a piezoelectric transducer (PZT). The displacement sensor is disposed near high-reflectivity cavity mirrors (e.g., the first fundamental-frequency high-reflectivity cavity mirror 101 and the second fundamental-frequency high-reflectivity cavity mirror 201), and the PZT is disposed in the high-reflectivity cavity mirrors (e.g., the first fundamental-frequency high-reflectivity cavity mirror 101 and the second fundamental-frequency high-reflectivity cavity mirror 201). More descriptions regarding the displacement sensor, the PZT, and the processor 7 may be found elsewhere in the present disclosure (e.g., FIG. 8 and related descriptions thereof).

In some embodiments, the dual-beam combining laser frequency-doubling device includes an electro-optical modulator, a first signal acquisition device, and a second signal acquisition device. The electro-optical modulator is arranged between the second fundamental frequency laser generation module 4 and the second harmonic separation mirror 203. The first signal acquisition device is arranged between the first fundamental frequency laser generation module 3 and the first harmonic separation mirror 103. The second signal acquisition device is arranged between the second fundamental frequency laser generation module 4 and the electro-optical modulator. More descriptions regarding the electro-optical modulator, the first signal acquisition device, and the second signal acquisition device may be found elsewhere in the present disclosure (e.g., FIG. 9 and related descriptions thereof).

Stable temperature helps maintain the stability of the laser resonant cavity. Temperature fluctuations may cause phase matching deviations, thereby reducing the frequency-doubling efficiency. The embodiments of the present disclosure can accurately control the temperature of the frequency-doubling crystals (e.g., the first frequency-doubling crystal 104 and the second frequency-doubling crystal 204) and/or the temperature of the working crystals (e.g., the first working crystal 102 and the second working crystal 202) by further providing the temperature sensor 5, the TEC 6, and the processor 7, thereby ensuring optimal phase matching conditions and maintaining high frequency doubling conversion efficiency. In addition, the embodiments of the present disclosure adopt an active temperature control mechanism, which can effectively reduce unstable factors caused by temperature fluctuations and improve the reliability of the dual-beam combining laser frequency-doubling device.

FIG. 8 is a schematic diagram illustrating an exemplary structure of a dual-beam combining laser frequency-doubling device according to some embodiments of the present disclosure.

In some embodiments, the dual-beam combining laser frequency-doubling device further includes a displacement sensor 8 and a piezoelectric transducer (PZT) 9. The displacement sensor 8 is disposed near high-reflectivity cavity mirrors (e.g., the first fundamental-frequency high-reflectivity cavity mirror 101 and the second fundamental-frequency high-reflectivity cavity mirror 201). The PZT 9 is disposed in the high-reflectivity cavity mirrors (e.g., the first fundamental-frequency high-reflectivity cavity mirror 101 and the second fundamental-frequency high-reflectivity cavity mirror 201).

The displacement sensor 8 is configured to convert a change of a position, a size, and/or a mechanical displacement of a cavity (e.g., a laser resonant cavity) into transmittable cavity length data. In some embodiments, the displacement sensor 8 is configured to collect cavity length data of two cavities (e.g., a cavity in which the first fundamental-frequency high-reflectivity cavity mirror 101 is located and a cavity in which the second fundamental-frequency high-reflectivity cavity mirror 201 is located). The displacement sensor 8 may be a high-precision displacement sensor, for example, the displacement sensor 8 may be a laser interferometer and a capacitive sensor. The displacement sensor 8 is configured to monitor the cavity length data (e.g., a cavity length and a cavity length variation) of the two cavities (e.g., the cavity in which the first fundamental-frequency high-reflectivity cavity mirror 101 is located and the cavity in which the second fundamental-frequency high-reflectivity cavity mirror 201 is located) in real time.

The PZT 9 is a device that converts electrical energy into mechanical energy or mechanical motion through a reverse piezoelectric effect (RPE) of a piezoe-lectric material (e.g., piezoe-lectric ceramics). By controlling a drive voltage, the PZT 9 may apply an electric field to the piezoe-lectric material (e.g., the piezoelectric ceramics) to cause the piezoe-lectric material (e.g., the piezoe-lectric ceramics) to generate controllable deformation (e.g., expansion, bending, and vibration), thereby driving or controlling a mechanical structure to achieve precise displacement, and regulating the cavity lengths of the two cavities (e.g., the cavity in which the first fundamental-frequency high-reflectivity cavity mirror 101 is located and the cavity in which the second fundamental-frequency high-reflectivity cavity mirror 201 is located).

In some embodiments, the PZT 9 may be embedded in the high-reflectivity cavity mirrors (e.g., the first fundamental-frequency high-reflectivity cavity mirror 101 and the second fundamental-frequency high-reflectivity cavity mirror 201) to achieve micrometer-level adjustment of the cavity lengths of two cavities (e.g., the cavity where the first fundamental-frequency high-reflectivity cavity mirror 101 is located, and the cavity where the second fundamental-frequency high-reflectivity cavity mirror 201 is located) by applying the drive voltage.

In some embodiments, the processor 7 is configured to determine a piezoelectric control parameter based on the cavity length data (e.g., the cavity lengths and the cavity length variations) collected by the displacement sensor 8 and transmit the piezoelectric control parameter to the PZT 9. The processor 7 is further configured to adjust the cavity lengths of the high-reflectivity cavity mirrors (e.g., the first fundamental-frequency high-reflectivity cavity mirror 101 and the second fundamental-frequency high-reflectivity cavity mirror 201) through the PZT 9.

The piezoelectric control parameter refers to a parameter used to set, regulate, or optimize a control process of the cavity length. In some embodiments, the piezoelectric control parameter may include the drive voltage of the PZT 9. For example, the piezoelectric control parameter may include drive voltages corresponding to multiple cavity length sampling cycles, where a cavity length sampling cycle refers to a period during which the displacement sensor 8 collects the cavity length data (e.g., the cavity length and the cavity length variation).

In some embodiments, the processor 7 may determine, based on the cavity length data (e.g., the cavity length and the cavity length variation) collected by the displacement sensor 8, the piezoelectric control parameter by looking up a second preset table. The second preset table includes a correspondence between the cavity length data, a preset cavity length, and the piezoelectric control parameter, e.g., {index 1 (cavity length data) and index 2 (preset cavity length)→query result (piezoelectric control parameter-drive voltage)}. The preset cavity length may be a factory-set standard cavity length and/or an original cavity length. The second preset table may be constructed based on data collected by experiments.

In some embodiments, the processor 7 is further configured to determine the piezoelectric control parameter through the second vector database based on the cavity length data, the preset cavity length, high-reflectivity cavity mirror data, and piezoelectric feature data. The high-reflectivity cavity mirrors (e.g., the first fundamental-frequency high-reflectivity cavity mirror 101 and the second fundamental-frequency high-reflectivity cavity mirror 201) data may include a material type of the high-reflectivity cavity mirror, size data of the high-reflectivity cavity mirror, or the like. The piezoelectric feature data may include a type of the PZT, a material type of the PZT, or the like.

In some embodiments, the processor 7 may conduct experiments under different experimental conditions (e.g., different types of high-reflectivity cavity mirrors and different types of PZTs) to obtain reference cavity length data, reference high-reflectivity cavity mirror data, and reference piezoelectric feature data; and construct a plurality of reference piezoelectric feature vectors based on the reference cavity length data, the preset cavity length, the reference high-reflectivity cavity mirror data. Each of the reference piezoelectric feature vectors corresponds to a piezoelectric vector label. The piezoelectric vector label may be a reference piezoelectric control parameter (e.g., a reference drive voltage) for adjusting the cavity length data of the high-reflectivity cavity mirrors (e.g., the first fundamental-frequency high-reflectivity cavity mirror 101 and the second fundamental-frequency high-reflectivity cavity mirror 201) to the preset cavity length under a corresponding experimental condition. The processor 7 may store the plurality of reference piezoelectric feature vectors and the corresponding reference piezoelectric control parameters (e.g., reference drive voltages) in the first vector database (e.g., Milvus or Faiss).

The processor 7 may construct a piezoelectric feature vector to be matched based on the cavity length data of the high-reflectivity cavity mirrors (e.g., the first fundamental-frequency high-reflectivity cavity mirror 101 and the second fundamental-frequency high-reflectivity cavity mirror 201), the preset cavity length, the high-reflectivity cavity mirror data, the high-reflectivity cavity mirror data, and the piezoelectric feature data. The processor 7 may determine a similarity (e.g., a Euclidean distance or a cosine similarity) of the piezoelectric feature vector to be matched to each of the plurality of reference piezoelectric feature vectors, and designate the piezoelectric vector label of the reference piezoelectric feature vector with the highest similarity as the piezoelectric control parameter (e.g., the drive voltage).

In some embodiments, the processor 7 may transmit the piezoelectric control parameter (e.g., the drive voltage) to the PZT 9 through serial communication, a general I/O interface, an ADC/DAC interface, or the like. The PZT 9 adjusts the cavity length of the high-reflectivity cavity mirrors (e.g., the first fundamental-frequency high-reflectivity cavity mirror 101 and the second fundamental-frequency high-reflectivity cavity mirror 201) based on the piezoelectric control parameter (e.g., the drive voltage).

In some embodiments, the processor 7 is further configured to determine the temperature control parameter and the piezoelectric control parameter through a stability control model based on the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202), the cavity length data of the high-reflectivity cavity mirrors (e.g., the first fundamental-frequency high-reflectivity cavity mirror 101 and the second fundamental-frequency high-reflectivity cavity mirror 201), the crystal feature data, the TEC feature data, the high-reflectivity cavity mirror data, the piezoelectric feature data, the preset crystal temperature, and the preset cavity length; and transmit the temperature control parameter and the piezoelectric control parameter to the TEC 6 and the PZT 9, respectively.

More descriptions regarding the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202), the crystal feature data, the TEC feature data, and the preset crystal temperature may be found elsewhere in the present disclosure (e.g., FIG. 7(a)~(c) and related descriptions thereof).

Inputs of the stability control model include the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202), the cavity length data of the high-reflectivity cavity mirrors (e.g., the first fundamental-frequency high-reflectivity cavity mirror 101 and the second fundamental-frequency high-reflectivity cavity mirror 201), the crystal feature data, the TEC feature data, the high-reflectivity cavity mirror data, the piezoelectric feature data, the preset crystal temperature, and the preset cavity length, and outputs of the stability control model include the temperature control parameter and the piezoelectric control parameter.

In some embodiments, the stability control model may be a deep learning model, for example, a convolutional neural network (CNN) model, a recurrent neural network (RNN) model, a long short-term memory (LSTM) model, etc.

In some embodiments, the training of the stability control model may be performed in a high-performance processor, and the trained stability control model may be ported from the high-performance processor to the processor 7. The high-performance processor refers to a central processor or a dedicated processing unit that performs superiorly in terms of computing speed, parallel processing speed, energy efficiency ratio, etc. For example, the high-performance processor may include a plurality of cores, a large-capacity cache, a dedicated acceleration unit, or the like.

The stability control model may be acquired by training based on at least one set of first training samples and a first label corresponding to each set of the at least one set of first training samples. In some embodiments, the first training samples for training the stability control model may include at least one set of first training samples corresponding to each of different experimental conditions (e.g., different crystal types, different TEC types, different high-reflectivity cavity mirror types, different PZT types), wherein one set of first training samples include temperature data, a preset crystal temperature, sample cavity length data, sample crystal feature data, sample TEC feature data, a preset cavity length, sample high-reflectivity cavity mirror data, and sample piezoelectric feature data. The first label of the set of first training samples may include the temperature control parameter (e.g., the drive current) for adjusting the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202) to the preset crystal temperature, and the piezoelectric control parameter (e.g., the drive voltage) for adjusting the cavity length data of the high-reflectivity cavity mirrors (e.g., the first fundamental-frequency high-reflectivity cavity mirror 101 and the second fundamental-frequency high-reflectivity cavity mirror 201) to the preset cavity length.

During the training of the stability control model, the first training samples are input into an initial stability control model, a loss function is constructed based on an output of the initial stability control model and the first label, and parameters of the initial stability control model are iteratively updated (e.g., using a gradient descent manner) based on the loss function. The training is completed when a preset training condition is met, and a trained stability control model is obtained. The trained stability control model is designated as the stability control model. The preset training condition may include, but is not limited to, the loss function converging, a count of training iterations reaching a threshold, or the like.

More descriptions regarding the piezoelectric control parameter may be found elsewhere in the present disclosure (e.g., FIG. 10 and related descriptions thereof).

The embodiments of the present disclosure comprehensively consider the temperature data of the frequency-doubling crystals (e.g., the first frequency-doubling crystal 104 and the second frequency-doubling crystal 204) and/or the temperature data of the working crystals (e.g., the first working crystal 102 and the second working crystal 202), the cavity length data of the high-reflectivity cavity mirrors (e.g., the first fundamental-frequency high-reflectivity cavity mirror 101 and the second fundamental-frequency high-reflectivity cavity mirror 201), the crystal feature data, the TEC feature data, the high-reflectivity cavity mirror data, the piezoelectric feature data, the preset crystal temperature, and the preset cavity length to determine the temperature control parameter and the piezoelectric control parameter, thereby enabling a more comprehensive evaluation of the state of the dual-beam combining laser frequency-doubling device. Furthermore, based on the temperature control parameter and the piezoelectric control parameter, the temperature of the frequency-doubling crystals (e.g., the first frequency-doubling crystal 104 and the second frequency-doubling crystal 204) and/or the temperature of the working crystals (e.g., the first working crystal 102 and the second working crystal 202) and the cavity length of the high-reflectivity cavity mirrors (e.g., the first fundamental-frequency high-reflectivity cavity mirror 101 and the second fundamental-frequency high-reflectivity cavity mirror 201) are regulated, thereby avoiding the limitations of adjusting a single parameter (e.g., regulating only the crystal temperature may cause thermal stress). Moreover, the embodiments of the present disclosure use the trained stability control model to automatically determine the temperature control parameter and the piezoelectric control parameter, which improves parameter control efficiency and accuracy and reduces operational difficulty and cost.

Since the cavity length directly affects the performance of laser frequency doubling, the embodiments of the present disclosure enable real-time monitoring and adjustment of the cavity length of high-reflectivity cavity mirrors (e.g., the first high-reflectivity cavity mirror 101 and the second high-reflectivity cavity mirror 201), thereby ensuring that laser frequency-doubling device operates under an optimal working condition, which reduces mode hopping caused by variations in the cavity length, thereby improving the stability and consistency of the output laser. At the same time, even under changing environmental conditions, the dual-beam combining laser frequency-doubling device can maintain optimal performance by adjusting the cavity length of the high-reflectivity cavity mirrors (e.g., the first fundamental-frequency high-reflectivity cavity mirror 101 and the second fundamental-frequency high-reflectivity cavity mirror 201), thereby improving the applicability of the laser frequency-doubling device under harsh environments.

FIG. 9 is a schematic diagram illustrating an exemplary structure of a dual-beam combining laser frequency-doubling device according to some embodiments of the present disclosure.

In some embodiments, the dual-beam combining laser frequency-doubling device further includes an electro-optical modulator 10, a first signal acquisition device 11, and a second signal acquisition device 12. The electro-optical modulator 10 is disposed between the second fundamental frequency laser generation module 4 and the second harmonic separation mirror 203, the first signal acquisition device 11 is disposed between the first fundamental frequency laser generation module 3 and the first harmonic separation mirror 103, and the second signal acquisition device 12 is disposed between the second fundamental frequency laser generation module 4 and the electro-optical modulator 10.

The electro-optical modulator 10 refers to an optical device that converts an electrical signal into an optical signal and/or modulates a parameter (e.g., an intensity, a phase, a frequency, and a polarization state) of the optical signal through an electro-optic effect (e.g., a linear electro-optic effect).

In some embodiments, the electro-optical modulator 10 may use a LiNbO₃ (lithium niobate) crystal as an electro-optic material of the electro-optical modulator 10. The electro-optical modulator 10 changes a refractive index of the crystal by applying an electric field, thereby regulating a propagation feature of a light wave in the crystal and realizing precise modulation of the optical signal. When a voltage (e.g., a 0-5 V voltage signal output by a digital signal processor (DSP)) is applied to the LiNbO₃ crystal, the refractive index of the LiNbO₃ crystal changes linearly with an intensity of the electric field. The change of the refractive index caused by the electric field leads to a change of the optical phase, amplitude, or polarization state of the light wave, thereby enabling precise control of pulse delay. In some embodiments, the DSP may be part of the electro-optical modulator 10.

The first signal acquisition device 11 refers to an electronic device that is configured to collect various physical signals (e.g., a light signal, an electricity signal, a temperature signal, a pressure signal, a vibration signal, etc.) and convert the collected physical signals into digital signals suitable for processing, storage, or transmission. The first signal acquisition device 11 may include a sensor interface, a signal conditioning circuit (amplification, filtering), an analog-to-digital converter (ADC) module, and a communication interface. In some embodiments, the first signal acquisition device 11 may be a high-speed photodetector. For example, the first signal acquisition device 11 may be an indium gallium arsenide (InGaAs) detector. In some embodiments, the first signal acquisition device 11 is configured to monitor pulse waveforms in real time.

The second signal acquisition device 12 is similar to the first signal acquisition device 11. More descriptions regarding the second signal acquisition device 12 may be found elsewhere in the present disclosure (e.g., the first signal acquisition device 11 and related descriptions thereof).

In some embodiments, the processor 7 is configured to generate a modulation control parameter based on a first pulse waveform acquired by the first signal acquisition device 11 and a second pulse waveform acquired by the second signal acquisition device 12, transmit the regulation control parameter to the electro-optical modulator 10, and regulate a relative time delay between the first pulse waveform and the second pulse waveform through the electro-optical modulator 10.

The modulation control parameter refers to a parameter that regulates the relative time delay between the two pulse signals by adjusting the electrical signal parameter to control a phase, an intensity, or a propagation time of light. In some embodiments, the modulation control parameter may include a voltage adjustment amount, a voltage amplitude, an electric field intensity, a modulation frequency, a phase offset, pulse timing, a bias voltage, a drive current, or the like.

The relative time delay refers to a difference in transmission time between two pulse signals or a difference in transmission time between two pulse waveforms. The relative time delay is used to characterize a temporal sequence or a time interval between two pulse signals or pulse waveforms during transmission, processing, or upon reaching a reference point. The relative time delay may be fixed (e.g., a static delay) or dynamically variable (e.g., controlled by the modulation control parameter). For example, the relative time delay may represent the temporal difference between a feature point (e.g., a point on a rising edge, a peak point, and a point on a falling edge) of one pulse signal/waveform and the same or different feature point of another pulse signal/waveform.

In some embodiments, the processor 7 may perform a cross-correlation analysis between the first pulse waveform and the second pulse waveform to determine a delay value Δτ current. The processor 7 may generate, based on the delay value Δτ current, the modulation control parameter (e.g., a voltage adjustment amount ΔV) through a PID controller. For example, the processor 7 may set a target delay value Δτ target=0 (i.e., the two pulse waveforms are completely synchronized) to generate, based on Δτ error=Δτ current−Δτ target, the voltage adjustment amount ΔV of the electro-optical modulator 10 through the PID controller. The PID controller may be set based on Equation (1):

$$Δ V = {K}_{P} \cdot {Δτ}_{error} + {K}_{i} \cdot \int Δ {τ}_{error} {d}_{t} + {K}_{d} \cdot \frac{d ( Δ {τ}_{error} )}{{d}_{t}} . \qquad ( 1 )$$

In Equation (1), ΔV denotes the voltage adjustment amount, Kₚ denotes a proportional gain, Kᵢ denotes an integral gain, K_{d} denotes a derivative gain, Δτₑᵣᵣₒᵣ denotes error compensation, and t denotes a preset time value (i.e., a system preset time value) of the PID controller. In some embodiments, Kₚ may be increased from 0 until an initial oscillation occurs in the PID controller, then set to 60% of a critical value (i.e., a Kₚ critical value corresponding to the initial oscillation); Kᵢ may be set to 0.1 to 0.3 times Kₚ; and K_{d} may be set to 0.05 to 0.2 times Kₚ.

More descriptions regarding the modulation control parameter may be found elsewhere in the present disclosure (e.g., FIG. 10 and related descriptions thereof).

In some embodiments, the processor 7 may transmit the modulation control parameter (e.g., the voltage adjustment amount ΔV) to the electro-optical modulator 10 through serial communication, a general I/O interface, an ADC/DAC interface, or the like. The electro-optical modulator 10 regulates the relative time delay between the first pulse waveform and the second pulse waveform based on the modulation control parameter (e.g., the voltage adjustment amount ΔV).

In some embodiments of the present disclosure, the processor 7 may generate the modulation control parameter (e.g., the voltage adjustment amount) based on the first pulse waveform acquired by the first signal acquisition device 11 and the second pulse waveform acquired by the second signal acquisition device 12. The processor 7 may further use an electro-optic modulator 10 made of the LiNbO₃ material to apply the modulation control parameter, thereby changing the refractive index of the electro-optic modulator 10 and enabling fine adjustment of the optical path of the pulse waveforms. The modulation manner of the embodiments of the present disclosure improves the performance of the dual-beam combining laser frequency-doubling device in terms of time synchronization, beam quality, stability, and intelligence.

FIG. 10 is a schematic diagram illustrating an exemplary structure of a comprehensive control model according to some embodiments of the present disclosure.

In some embodiments, the processor 7 is configured to acquire a candidate optimization parameter; determine an optimization control score through a comprehensive control model 13 based on the candidate optimization parameter, a first pulse waveform, a second pulse waveform, temperature data of frequency-doubling crystals (e.g., the first frequency-doubling crystal 104 and the second frequency-doubling crystal 204) and/or temperature data of working crystals (e.g., the first working crystal 102 and the second working crystal 202), cavity length data of high-reflectivity cavity mirrors (e.g., the first fundamental-frequency high-reflectivity cavity mirror 101 and the second fundamental-frequency high-reflectivity cavity mirror 201), crystal feature data, high-reflectivity cavity mirror data, and device monitoring data; and determine a target optimization parameter based on the optimization control score. The processor 7 is configured to determine an optimized temperature parameter, an optimized piezoelectric parameter, and an optimized modulation parameter based on the target optimization parameter, transmit the optimized temperature parameter to the TEC 6, transmit the optimized piezoelectric parameter to the PZT 9, and transmit the optimized modulation parameter to the electro-optical modulator 10.

The candidate optimization parameter refers to an optimization parameter to be selected. The optimization parameter is used to optimize the stability of the dual-beam combining laser frequency-doubling device. In some embodiments, the candidate optimization parameter may include a candidate crystal temperature, a candidate cavity length, and a candidate relative time delay.

In some embodiments, the processor 7 may designate a historical optimization parameter as the candidate optimization parameter. For example, the processor 7 may designate a plurality of historical crystal temperatures as candidate crystal temperatures; designate a plurality of historical cavity lengths as candidate cavity lengths; and designate a plurality of historical relative time delays as candidate relative time delays.

In some embodiments, the processor 7 may randomly adjust the historical optimization parameter within a preset range to obtain the candidate optimization parameter. The preset range may be determined based on experience or may be a system-defined preset range. For example, if the historical crystal temperature is 20° C., the processor 7 may randomly adjust within the historical crystal temperature a preset temperature range [0° C. to 5° C.] (e.g., 20° C.±1° C., 20° C.±2° C., 20° C.±3° C., etc.) to obtain the candidate crystal temperature. The manner of obtaining the candidate cavity length and the candidate relative time delay is similar to the manner of obtaining the candidate crystal temperature, which is not repeated here.

In some embodiments, the comprehensive control model 13 may be a deep learning model, e.g., a convolutional neural network (CNN) model, a recurrent neural network (RNN) model, a long short-term memory (LSTM) model, etc. In some embodiments, the training of the comprehensive control model 13 may be performed in a high-performance processor, and the trained comprehensive control model 13 may be ported from the high-performance processor to the processor 7. More descriptions regarding the high-performance processor may be found elsewhere in the present disclosure (e.g., FIG. 8 and related descriptions thereof).

The optimization control score refers to a score of the candidate optimization parameter. In some embodiments, the optimization control score may be a quantitative value representing device stability (i.e., stability of the dual-beam combining laser frequency-doubling device) and a frequency-doubling efficiency corresponding to the candidate optimization parameter. For example, the optimization control score is positively correlated to the device stability and the frequency-doubling efficiency. The higher the optimization control score is, the higher the device stability and the frequency-doubling efficiency of a corresponding set of candidate optimization parameters are.

In some embodiments, the processor 7 is configured to determine the optimization control score of the candidate optimization parameter by the comprehensive control model 13 based on the candidate optimization parameter, the first pulse waveform, the second pulse waveform, the temperature data of the frequency-doubling crystal and/or the working crystal, the cavity length data of the high-reflectivity cavity mirror, the crystal feature data, the high-reflectivity cavity mirror data, and the device monitoring data. That is to say, inputs of the comprehensive control model 13 are the candidate optimization parameter, the first pulse waveform, the second pulse waveform, the temperature data of the frequency-doubling crystal and/or the working crystal, the cavity length data of the high-reflectivity cavity mirror, the crystal feature data, the high-reflectivity cavity mirror data, and the device monitoring data, and an output of the comprehensive control model 13 is the optimization control score of the candidate optimization parameter.

The device monitoring data refers to data that is collected, recorded, and analyzed in real time for a parameter of an output beam generated by frequency-doubling after combining two laser beams. In some embodiments, the device monitoring data may include optical performance parameters, such as power, energy, frequency, wavelength, beam quality, phase, polarization, or the like.

In some embodiments, the device monitoring data may include the power of a fundamental frequency laser (e.g., a first target fundamental frequency laser and a second target fundamental frequency laser) input to the dual-beam combining laser frequency-doubling device, the power of a frequency-doubled laser (e.g., a first target frequency-doubled laser, a second target frequency-doubled laser, a first residual frequency-doubled laser, a third target frequency-doubled laser, a fourth target frequency-doubled laser, a fifth target frequency-doubled laser, and a sixth target frequency-doubled laser) output by the dual-beam combining laser frequency-doubling device.

In some embodiments, the power of the fundamental frequency laser and the power of the frequency-doubled laser may be directly measured and obtained by a laser power meter (e.g., a thermally-absorbing laser power meter and a photodetectable laser power meter).

More descriptions regarding the first pulse waveform, the second pulse waveform, the temperature data of the frequency-doubling crystals (e.g., the first frequency-doubling crystal 104 and the second frequency-doubling crystal 204) and/or the working crystals (e.g., the first working crystal 102 and the second working crystal 202), the cavity length data of the high-reflectivity cavity mirrors (e.g., the first fundamental-frequency high-reflectivity cavity mirror 101 and the second fundamental-frequency high-reflectivity cavity mirror 201), the crystal feature data, the high-reflectivity cavity mirror data may be found elsewhere in the present disclosure (e.g., FIGS. 7-9 and related descriptions thereof).

The comprehensive control model 13 may be acquired by training based on at least one set of second training samples and a second label corresponding to each set of the at least one set of second training samples. In some embodiments, the second training samples for training the comprehensive control model may include at least one set of second training samples corresponding to each of different experimental conditions (e.g., different crystal types, different thermoelectric cooler types, different high-reflectivity cavity mirror types, different PZT types, different electro-optical modulator types, and different signal acquisition device types), wherein one set of second training samples include a sample optimization parameter, a sample first pulse waveform, a sample second pulse waveform, sample temperature data, sample cavity length data, sample crystal feature data, sample high-reflectivity cavity mirror data, and sample device monitoring data. Under an experimental condition, the sample optimization parameter, the sample first pulse waveform, the sample second pulse waveform, the sample temperature data, the sample cavity length data, the sample crystal feature data, the sample high-reflectivity cavity mirror data, and the sample device monitoring data corresponding to the experimental condition are used to obtain the frequency-doubling efficiency and the modulation stability of the dual-beam combining laser frequency-doubling device used in the experiment corresponding to the experimental condition, and the optimization control score corresponding to the frequency-doubling efficiency and the modulation stability are designated as the second label of the set of second training samples.

The training manner of the comprehensive control model 13 is similar to the training manner of the stability control model, which may be found elsewhere in the present disclosure (e.g., FIG. 8 and related descriptions thereof).

In some embodiments, the processor 7 may rank the optimization control scores of a plurality of sets of candidate optimization parameters and designate a set of candidate optimization parameters with the highest optimization control score as the target optimization parameter. The target optimization parameter includes a target crystal temperature, a target cavity length, and a target relative time delay.

In some embodiments, the processor 7 may determine the optimized temperature parameter based on the target crystal temperature and send the optimized temperature parameter to the TEC 6. The optimized temperature parameter is similar to the temperature control parameter. The manner of determining the optimized temperature parameter by the processor 7 based on the target crystal temperature is similar to the manner of determining the temperature control parameter based on the temperature data acquired by the temperature sensor 5 and the preset crystal temperature, and more descriptions may be found elsewhere in the present disclosure (e.g., FIGS. 7(a) to (c) and related descriptions thereof).

In some embodiments, the processor 7 may determine the optimized piezoelectric parameter based on the target cavity length and send the optimized piezoelectric parameter to the PZT 9. The optimized piezoelectric parameter is similar to the piezoelectric control parameter. The manner of determining the optimized piezoelectric parameter by the processor 7 based on the target cavity length is similar to the manner of determining the piezoelectric control parameter based on the cavity length data acquired by the displacement sensor 8 and the preset cavity length, and more descriptions may be found elsewhere in the present disclosure (e.g., FIG. 8 and related descriptions thereof).

In some embodiments, the processor 7 may determine the optimized modulation parameter based on the target relative time delay and send the optimized modulation parameter to the electro-optical modulator 10. The optimized modulation parameter is similar to the modulation control parameter. The manner of determining the optimized modulation parameter by the processor 7 based on the target relative time delay is similar to the manner of generating the modulation control parameter through a PID controller based on a delay value of Δτ current and a target delay value of Δτ target. More descriptions may be found elsewhere in the present disclosure (e.g., FIG. 9 and related descriptions thereof).

The embodiment of the present disclosure integrates the crystal temperature control, the cavity length regulation, and the pulse delay adjustment into the comprehensive control model 13 for global optimization, thereby preventing negative effects caused by adjusting a single parameter. The trained comprehensive control model 13 is configured to perform optimization control scoring on the candidate optimization parameter and determine the target optimization parameter, thus realizing a shift from an experience-driven approach to a data-driven approach. Moreover, the embodiments of the present disclosure dynamically adjust the temperature control parameter, the piezoelectric control parameter, and the modulation control parameter based on the real-time temperature data, the cavity length data, and the delay value, ensuring that the dual-beam combining laser frequency-doubling device maintains the optimal performance under different working conditions, thereby improving the quality of the output beam.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

It should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the count of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A dual-beam combining laser frequency-doubling device, comprising a first frequency-doubling module and a second frequency-doubling module, wherein
the first frequency-doubling module and the second frequency-doubling module share a dual-sided harmonic separation mirror;
the first frequency-doubling module includes a first harmonic separation mirror and a first frequency-doubling crystal; the second frequency-doubling module includes a second harmonic separation mirror and a second frequency-doubling crystal;
an end of the first harmonic separation mirror is connected to an end of the first frequency-doubling crystal, and another end of the first frequency-doubling crystal is connected to an end of the dual-sided harmonic separation mirror; and
another end of the dual-sided harmonic separation mirror is connected to an end of the second frequency-doubling crystal, and another end of the second frequency-doubling crystal is connected to an end of the second harmonic separation mirror.

2. The dual-beam combining laser frequency-doubling device of claim 1, wherein: the first frequency-doubling module is externally connected to a first fundamental frequency laser generation module; the second frequency-doubling module is externally connected to a second fundamental frequency laser generation module;
the first fundamental frequency laser generation module is connected to another end of the first harmonic separation mirror; and
the second fundamental frequency laser generation module is connected to another end of the second harmonic separation mirror.

3. The dual-beam combining laser frequency-doubling device of claim 2, wherein the first fundamental frequency laser generation module generates a first target fundamental frequency laser;
the first target fundamental frequency laser passes through the first harmonic separation mirror and then enters the first frequency-doubling crystal;
after the first target fundamental frequency laser enters the first frequency-doubling crystal, frequency-doubling is performed to obtain a first target frequency-doubled laser, wherein the first target frequency-doubled laser is a frequency-doubled laser generated after the frequency-doubling is performed on the first target fundamental frequency laser; and
the first target frequency-doubled laser sequentially passes through the dual-sided harmonic separation mirror and the second frequency-doubling crystal, and is reflected and output by the second harmonic separation mirror.

4. The dual-beam combining laser frequency-doubling device of claim 2, wherein the second fundamental frequency laser generation module generates a second target fundamental frequency laser;
the second target fundamental frequency laser passes through the second harmonic separation mirror and then enters the second frequency-doubling crystal;
after the second target fundamental frequency laser enters the second frequency-doubling crystal, frequency-doubling is performed to obtain a second target frequency-doubled laser, wherein the second target frequency-doubled laser is a frequency-doubled laser generated after the frequency-doubling is performed on the second target fundamental frequency laser;
the second target frequency-doubled laser sequentially passes through the dual-sided harmonic separation mirror and the first frequency-doubling crystal, and is reflected by the first harmonic separation mirror; and
the reflected second target frequency-doubled laser sequentially passes through the first frequency-doubling crystal, the dual-sided harmonic separation mirror, and the second frequency-doubling crystal, and is reflected and output by the second harmonic separation mirror.

5. The dual-beam combining laser frequency-doubling device of claim 4, wherein,
after the second target fundamental frequency laser enters the second frequency-doubling crystal, frequency-doubling is performed to obtain a first residual fundamental frequency laser, wherein the first residual fundamental frequency laser is a portion of the second target fundamental frequency laser that is undoubled;
the first residual fundamental frequency laser is reflected by the dual-sided harmonic separation mirror and re-enters the second frequency-doubling crystal, where frequency-doubling is performed to obtain a first residual frequency-doubled laser; and
the first residual frequency-doubled laser is reflected and output by the second harmonic separation mirror.

6. The dual-beam combining laser frequency-doubling device of claim 1, wherein
the first frequency-doubling module further includes a first fundamental-frequency high-reflectivity cavity mirror and a first working crystal;
the second frequency-doubling module further includes a second fundamental-frequency high-reflectivity cavity mirror and a second working crystal;
an end of the first fundamental-frequency high-reflectivity cavity mirror is connected to an end of the first working crystal, and another end of the first working crystal is connected to another end of the first harmonic separation mirror; and
another end of the second harmonic separation mirror is connected to an end of the second working crystal, and another end of the second working crystal is connected to an end of the second fundamental-frequency high-reflectivity cavity mirror.

7. The dual-beam combining laser frequency-doubling device of claim 6, wherein
the first working crystal generates a third target fundamental frequency laser;
the third target fundamental frequency laser passes through the first harmonic separation mirror and enters the first frequency-doubling crystal;
after the third target fundamental frequency laser enters the first frequency-doubling crystal, frequency-doubling is performed to obtain a third target frequency-doubled laser, wherein the third target frequency-doubled laser is a frequency-doubled laser generated after the frequency-doubling is performed on the third target fundamental frequency laser; and
the third target frequency-doubled laser passes through the second frequency-doubling crystal and is reflected and output by the second harmonic separation mirror.

8. The dual-beam combining laser frequency-doubling device of claim 7, wherein, after the third target fundamental frequency laser enters the first frequency-doubling crystal, the following steps are performed:
S1: after the third target fundamental frequency laser enters the first frequency-doubling crystal, frequency-doubling is performed to obtain a second residual fundamental frequency laser, wherein the second residual fundamental frequency laser is a portion of the third target fundamental frequency laser that is undoubled;
S2: the second residual fundamental frequency laser is reflected by the dual-sided harmonic separation mirror and re-enters the first frequency-doubling crystal, where frequency-doubling is performed to obtain a third residual fundamental frequency laser, wherein the third residual fundamental frequency laser is a portion of the second residual fundamental frequency laser that is undoubled;
S3: the third residual fundamental frequency laser passes through the first harmonic separation mirror, and passes through the first working crystal for fundamental frequency laser enhancement to obtain a first enhanced fundamental frequency laser;
S4: the first enhanced fundamental frequency laser is reflected by the first fundamental-frequency high-reflectivity cavity mirror, and passes through the first working crystal for further fundamental frequency laser enhancement to obtain a second enhanced fundamental frequency laser;
S5: the second enhanced fundamental frequency laser passes through the first harmonic separation mirror and enters the first frequency-doubling crystal, where frequency-doubling is performed to obtain a fourth target frequency-doubled laser and a first non-enhanced fundamental frequency laser, wherein:
the first non-enhanced fundamental frequency laser is designated as the second residual fundamental frequency laser, returning to S2;
the fourth target frequency-doubled laser is a frequency-doubled laser that is generated after the frequency-doubling is performed on the second enhanced fundamental frequency laser;
the first non-enhanced fundamental frequency laser is a portion of the second enhanced fundamental frequency laser that is undoubled; and
S6: the fourth target frequency-doubled laser passes through the second frequency-doubling crystal and is reflected and output by the second harmonic separation mirror.

9. The dual-beam combining laser frequency-doubling device of claim 6, wherein
the second working crystal generates a fourth target fundamental frequency laser;
the fourth target fundamental frequency laser passes through the second harmonic separation mirror and enters the second frequency-doubling crystal;
after the fourth target fundamental frequency laser enters the second frequency-doubling crystal, frequency-doubling is performed to obtain a fifth target frequency-doubled laser, wherein the fifth target frequency-doubled laser is a frequency-doubled laser generated after the frequency-doubling is performed on the fourth target fundamental frequency laser;
the fifth target frequency-doubled laser sequentially passes through the dual-sided harmonic separation mirror and the first frequency-doubling crystal, and is reflected by the first harmonic separation mirror; and
the reflected fifth target frequency-doubled laser sequentially passes through the first frequency-doubling crystal, the dual-sided harmonic separation mirror, and the second frequency-doubling crystal, and is reflected and output by the second harmonic separation mirror.

10. The dual-beam combining laser frequency-doubling device of claim 9, wherein, after the fourth target fundamental frequency laser enters the second frequency-doubling crystal, the following steps are performed:
Step 1: the fourth target fundamental frequency laser enters the second frequency-doubling crystal, where frequency-doubling is performed to obtain a fourth residual fundamental frequency laser, wherein the fourth residual fundamental frequency laser is a portion of the fourth target fundamental frequency laser that is undoubled;
Step 2: the fourth residual fundamental frequency laser is reflected by the dual-sided harmonic separation mirror and re-enters the second frequency-doubling crystal, where frequency-doubling is performed to obtain a fifth residual fundamental frequency laser, wherein the fifth residual fundamental frequency laser is a portion of the fourth residual fundamental frequency laser that is undoubled;
Step 3: the fifth residual fundamental frequency laser passes through the second harmonic separation mirror, and passes through the second working crystal for fundamental frequency laser enhancement to obtain a third enhanced fundamental frequency laser;
Step 4: the third enhanced fundamental frequency laser is reflected by the second fundamental-frequency high-reflectivity cavity mirror, and passes through the second working crystal for further fundamental frequency laser enhancement to obtain a fourth enhanced fundamental frequency laser;
Step 5: the fourth enhanced fundamental frequency laser passes through the second harmonic separation mirror and enters the second frequency-doubling crystal, where frequency-doubling is performed to obtain a sixth target frequency-doubled laser and a second non-enhanced fundamental frequency laser, wherein:
the second non-enhanced fundamental frequency laser is designated as the fourth residual fundamental frequency laser, returning to Step 2;
the sixth target frequency-doubled laser is a frequency-doubled laser generated after the frequency-doubling is performed on the fourth enhanced fundamental frequency laser;
the second non-enhanced fundamental frequency laser is a portion of the fourth enhanced fundamental frequency laser that is undoubled; and
Step 6: the sixth target frequency-doubled laser sequentially passes through the dual-sided harmonic separation mirror and the first frequency-doubling crystal, is reflected by the first harmonic separation mirror, then passes again through the first frequency-doubling crystal, the dual-sided harmonic separation mirror, and the second frequency-doubling crystal, and is reflected and output by the second harmonic separation mirror.
